(19) United States
(12) Patent Application Publication
(10) Pub. No.: US 2023/0324236 A1
(43) Pub. Date: Oct. 12, 2023

(54) LOAD SENSOR

(71) Applicant: Panasonic Intellectual Property Management Co., Ltd., Osaka (JP)

(72) Inventors: Takashi MATSUMOTO, Osaka (JP); Hiroyuki FURUYA, Osaka (JP); Yuta MORIURA, Osaka (JP); Susumu URAGAMI, Osaka (JP); Yodai MATSUMURA, Osaka (JP)

(21) Appl. No.: 18/210,539

(22) Filed: Jun. 15, 2023

Related U.S. Application Data
(63) Continuation of application No. PCT/JP21/41621, filed on Nov. 11, 2021.

(30) Foreign Application Priority Data
Dec. 18, 2020 (JP) 2020/210786

(51) Int. Cl. G01L 1/14

(52) U.S. Cl. CPC G01L 1/142

(57) ABSTRACT

A load sensor includes: a base member; an electrically-conductive elastic body having a band-like shape and disposed on a surface of the base member; an electrically-conductive member disposed so as to be superposed on the electrically-conductive elastic body; a dielectric body provided between the electrically-conductive elastic body and the electrically-conductive member; and a substrate configured to connect the electrically-conductive elastic body and an external circuit. The substrate includes an electrode extending in a width direction and a length direction of the electrically-conductive elastic body, and is fixed to the base member in a state where the electrode is pressed against a surface of the electrically-conductive elastic body.

### CROSS REFERENCE TO RELATED APPLICATION

This application is a continuation of International Application No. PCT/JP2021/041621 filed on Nov. 11, 2021, entitled “LOAD SENSOR”, which claims priority under 35 U.S.C. Section 119 of Japanese Patent Application No. 2020-210786 filed on Dec. 18, 2020, entitled “LOAD SENSOR”. The disclosures of the above applications are incorporated herein by reference.

### BACKGROUND OF THE INVENTION

### Field of the Invention

The present invention relates to a load sensor that detects a load applied from outside, based on change in capacitance.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

International Publication No. 2020/153029 discloses a pressure-sensitive element that includes a pressure-sensitive part to which a pressing force is applied, and a detection part that detects a pressing force. The pressure-sensitive part includes: an elastic electrically-conductive part having elasticity and electrical conductivity; a conductor wire disposed so as to cross the elastic electrically-conductive part; and a dielectric body being an insulation coating that covers the surface of the conductor wire. The detection part is a circuit that detects a pressing force, based on change in capacitance between the elastic electrically-conductive part and the conductor wire.

In such a load sensor, the capacitance between the elastic electrically-conductive part and the conductor wire is detected, based on change in the value of voltage between the elastic electrically-conductive part and the conductor wire, for example. At this time, if the resistance value at the connection place between a wire on the detection part side and the elastic electrically-conductive part is large, it is difficult to accurately detect the voltage value between the elastic electrically-conductive part and the conductor wire. In this case, it is also difficult to accurately detect the capacitance between the elastic electrically-conductive part and the conductor wire, and thus, the detection accuracy of the pressing force (load) detected by the detection part is decreased.

### SUMMARY OF THE INVENTION

A first aspect of the present invention relates to a load sensor. The load sensor according to the present aspect includes: a base member; an electrically-conductive elastic body having a band-like shape and disposed on a surface of the base member; an electrically-conductive member disposed so as to be superposed on the electrically-conductive elastic body; a dielectric body provided between the electrically-conductive elastic body and the electrically-conductive member; and a substrate configured to connect the electrically-conductive elastic body and an external circuit. The substrate includes an electrode extending in a width direction and a length direction of the electrically-conductive elastic body, and is fixed to the base member in a state where the electrode is pressed against a surface of the electrically-conductive elastic body.

According to the load sensor of the present aspect, since the electrode and the electrically-conductive elastic body are in surface contact with each other, the contact area between the electrode and the electrically-conductive elastic body is increased. Therefore, the electric resistance at the interface between the electrode and the electrically-conductive elastic body can be suppressed to a low level, and the capacitance according to the load can be accurately detected.

The effects and the significance of the present invention will be further clarified by the description of the embodiments below. However, the embodiments below are merely examples for implementing the present invention. The present invention is not limited to the embodiments below in any way.

### BRIEF DESCRIPTION OF THE DRAWINGS

FIG. 1A is a perspective view schematically showing a state where three electrically-conductive elastic bodies are formed on the upper face of a base member, according to Embodiment 1;

FIG. 1B is a perspective view schematically showing a state where three pairs of conductor wires and threads set to each pair of conductor wires are set, according to Embodiment 1;

FIG. 2A is a perspective view schematically showing a configuration of a substrate, according to Embodiment 1;

FIG. 2B is a diagram schematically showing a C11-C12 cross section obtained by cutting the substrate along a plane parallel to a Y-Z plane passing through the centers of electrodes, according to Embodiment 1;

FIG. 3A is a perspective view schematically showing a state where the substrate is set, according to Embodiment 1;

FIG. 3B is a perspective view schematically showing a state where a thread for fixing the substrate is sewn, according to Embodiment 1;

FIG. 4A is a diagram schematically showing a C21-C22 cross section obtained by cutting a structure along a plane parallel to a Y-Z plane passing through the position of the thread, according to Embodiment 1;

FIG. 4B is a diagram schematically showing the positions of holes and the order of sewing the thread, according to Embodiment 1;

FIG. 5A and FIG. 5B are each a diagram schematically showing a modification of the positions of the holes and the order of sewing of the thread, according to Embodiment 1;

FIG. 6A is a perspective view schematically showing a state where a base member is set to the structure, according to Embodiment 1;

FIG. 6B is a diagram schematically showing a cross section C31-C32 obtained by cutting the load sensor along a plane parallel to an X-Z plane passing through the centers of the electrodes, according to Embodiment 1;

FIG. 7A and FIG. 7B are each a cross-sectional view schematically showing surroundings of a conductor wire viewed in an Y-axis positive direction, according to Embodiment 1;

FIG. 8 is a plan view schematically showing the inside of the load sensor viewed in a Z-axis negative direction, according to Embodiment 1;

FIG. 9A and FIG. 9B are each a diagram schematically showing a cross section obtained by cutting the load sensor along a plane parallel to an X-Z plane passing through the center of an electrode, according to a modification of Embodiment 1;

FIG. 10A and FIG. 10B are each a diagram schematically showing a cross section obtained by cutting the load sensor along a plane parallel to an X-Z plane passing through the center of an electrode, according to a modification Embodiment 1;

FIG. 11A is a diagram schematically showing a cross section obtained by cutting the load sensor along a plane parallel to an X-Z plane passing through the center of an electrode, according to Embodiment 2;

FIG. 11B is a diagram schematically showing a modification of a cross section obtained by cutting the load sensor along a plane parallel to an X-Z plane passing through the center of an electrode, according to Embodiment 2;

FIG. 12A and FIG. 12B are each a plan view schematically showing a configuration of an electrically-conductive elastic body, according to Embodiment 3;

FIG. 12C is a diagram schematically showing a cross section obtained by cutting the load sensor along a plane parallel to an X-Z plane passing through the center of an electrode, according to Embodiment 3;

FIG. 13A is a perspective view schematically showing a configuration of a structure, according to Embodiment 4;

FIG. 13B is a perspective view schematically showing a state where two structures are assembled, according to Embodiment 4;

FIG. 14A and FIG. 14B are each a diagram schematically showing a cross section of the vicinity of an electrode obtained by cutting the load sensor along a plane parallel to an X-Z plane passing through the center of the electrode, according to Embodiment 4;

FIG. 15 is a plan view schematically showing the inside of the load sensor viewed in the Z-axis negative direction, according to Embodiment 5;

FIG. 16A to FIG. 16D are each a plan view schematically showing a configuration of an electrode, according to another modification; and

FIG. 17 is a plan view schematically showing the inside of the load sensor viewed in the Z-axis negative direction, according another modification.

It is noted that the drawings are solely for description and do not limit the scope of the present invention in any way.

### DETAILED DESCRIPTION

The load sensor according to the present invention is applicable to a load sensor of a management system or an electronic apparatus that performs processing in accordance with an applied load.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

Examples of the electronic apparatus include a vehicle-mounted apparatus (car navigation system, audio apparatus, etc.), a household electrical appliance (electric pot, IH cooking heater, etc.), a smartphone, an electronic paper, an electronic book reader, a PC keyboard, a game controller, a smartwatch, a wireless earphone, a touch panel, an electronic pen, a penlight, lighting clothes, and a musical instrument. In an electronic apparatus, a load sensor is provided to an input part that receives an input from a user.

The load sensors in the embodiments below are each a capacitance-type load sensor that is typically provided in a load sensor of a management system or an electronic apparatus as described above. Such a load sensor may be referred to as a “capacitance-type pressure-sensitive sensor element”, a “capacitive pressure detection sensor element”, a “pressure-sensitive switch element”, or the like. The embodiments below are examples of embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

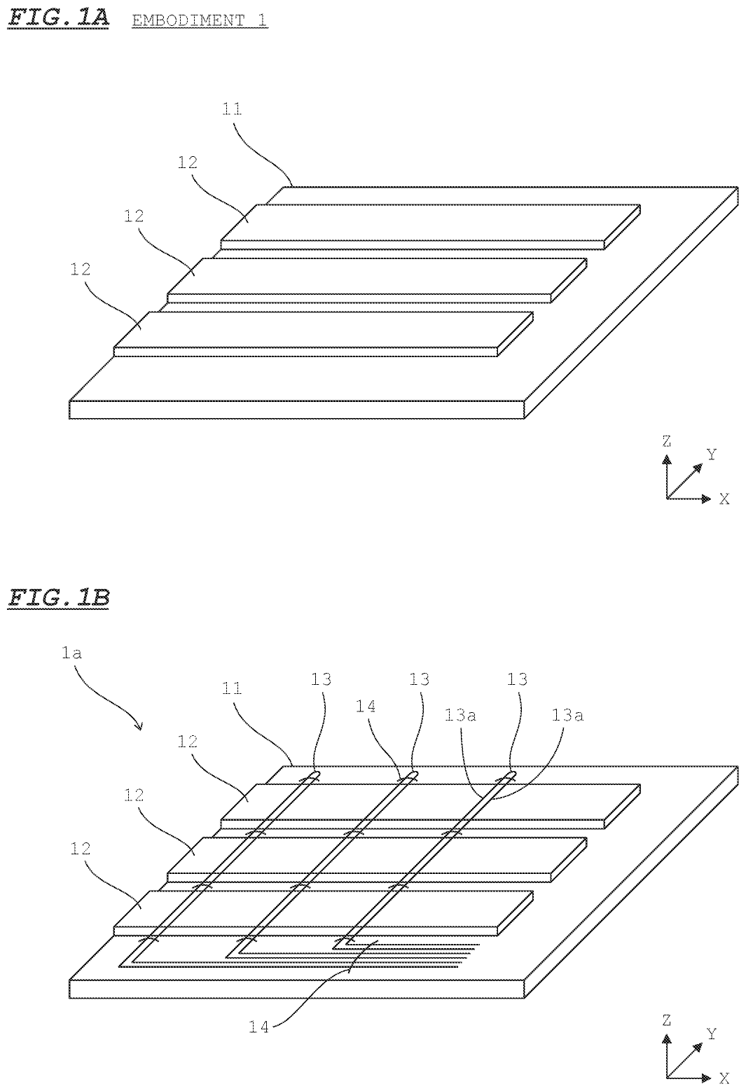

FIG. 1A is a perspective view schematically showing a state where three electrically-conductive elastic bodies 12 are formed on the upper face of a base member 11.

The base member 11 is an insulative member having elasticity. The base member 11 is a plate-shaped member having flat planes on the Z-axis positive side and the Z-axis negative side, and the planes on the Z-axis positive side and the Z-axis negative side of the base member 11 are parallel to an X-Y plane.

The base member 11 is formed from a non-electrically-conductive resin material or a non-electrically-conductive rubber material. The resin material used in the base member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the base member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the upper face (the surface on the Z-axis positive side) of the base member 11. In FIG. 1A, three electrically-conductive elastic bodies 12 are formed on the upper face of the base member 11. Each electrically-conductive elastic body 12 is an electrically-conductive member having elasticity. The electrically-conductive elastic bodies 12 each have a band-like shape that is long in the X-axis direction, and are formed so as to be arranged with a predetermined interval therebetween in the Y-axis direction.

Each electrically-conductive elastic body 12 is formed on the upper face of the base member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the upper face of the base member 11. However, the method for forming the electrically-conductive elastic body 12 is not limited to the printing methods.

Each electrically-conductive elastic body 12 is formed from a resin material and an electrically-conductive filler dispersed therein, or from a rubber material and an electrically-conductive filler dispersed therein.

Similar to the resin material used in the base member 11 described above, the resin material used in the electrically-conductive elastic body 12 is a resin material of at least one type selected from the group consisting of a styrene-based resin, a silicone-based resin (polydimethylpolysiloxane (e.g., PDMS)), an acrylic resin, a rotaxane-based resin, a urethane-based resin, and the like, for example. Similar to the rubber material used in the base member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler included in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); electrically-conductive fibers such as a metal-coated organic matter fiber and a metal wire (fiber state); and the like, for example. In Embodiment 1, the electrically-conductive filler included in the electrically-conductive elastic body 12 is C (carbon).

The length in the Y-axis direction of each electrically-conductive elastic body 12 is 10 mm, for example, and the interval (gap) between two electrically-conductive elastic bodies 12 adjacent to each other is 2 mm, for example.

FIG. 1B is a perspective view schematically showing a state where three pairs of conductor wires 13 and threads 14 set to each pair of conductor wires 13 are set to the structure in FIG. 1A.

Each pair of conductor wires 13 is formed by bending one conductor wire 13a extending in the Y-axis direction, and includes two conductor wires 13a extending from the bent position toward the Y-axis negative direction. The two conductor wires 13a forming the pair of conductor wires 13 are disposed so as to be arranged with a predetermined interval therebetween. The pair of conductor wires 13 is disposed so as to be superposed on the upper faces of the three electrically-conductive elastic bodies 12. Here, three pairs of conductor wires 13 are disposed so as to be superposed on the upper faces of the three electrically-conductive elastic bodies 12.

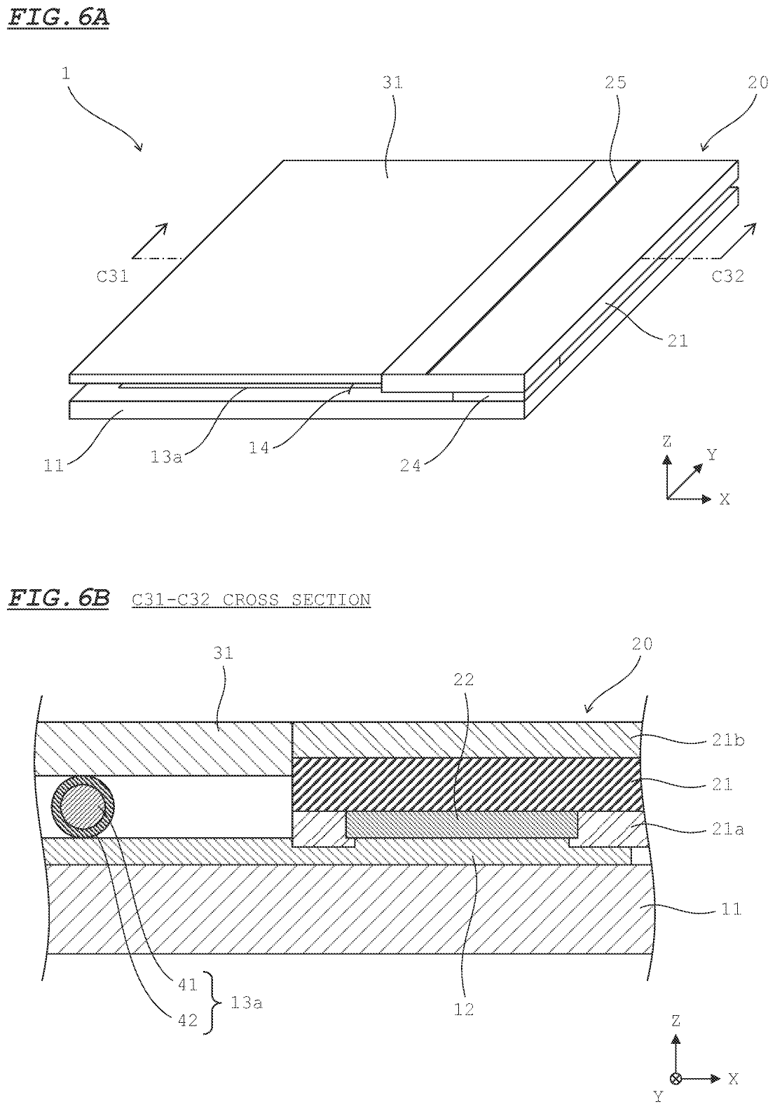

The three pairs of conductor wires 13 are disposed so as to cross the electrically-conductive elastic bodies 12, and are disposed so as to be arranged with a predetermined interval therebetween, along the longitudinal direction (the X-axis direction) of the electrically-conductive elastic bodies 12. Each pair of conductor wires 13 is disposed, extending in the Y-axis direction, so as to extend across the three electrically-conductive elastic bodies 12. The pair of conductor wires 13 is bent into the X-axis positive direction in the vicinity of an end portion on the Y-axis negative side of the base member 11, and is bundled. Each conductor wire 13a includes an electrically-conductive member having a linear shape, and a dielectric body formed on the surface of the electrically-conductive member. The configuration of the conductor wire 13a will be described later with reference to FIG. 6B.

After the three pairs of conductor wires 13 have been disposed as in FIG. 1B, each pair of conductor wires 13 is set on the base member 11 by threads 14 so as to be movable in the direction (the Y-axis direction) in which the pair of conductor wires 13 extends. In the example shown in FIG. 1B, twelve threads 14 set the pairs of conductor wires 13 to the base member 11 at positions other than the positions where the electrically-conductive elastic bodies 12 and the pairs of conductor wires 13 overlap each other. Each thread 14 is implemented by a chemical fiber, a natural fiber, a mixed fiber of the chemical fiber and the natural fiber, or the like.

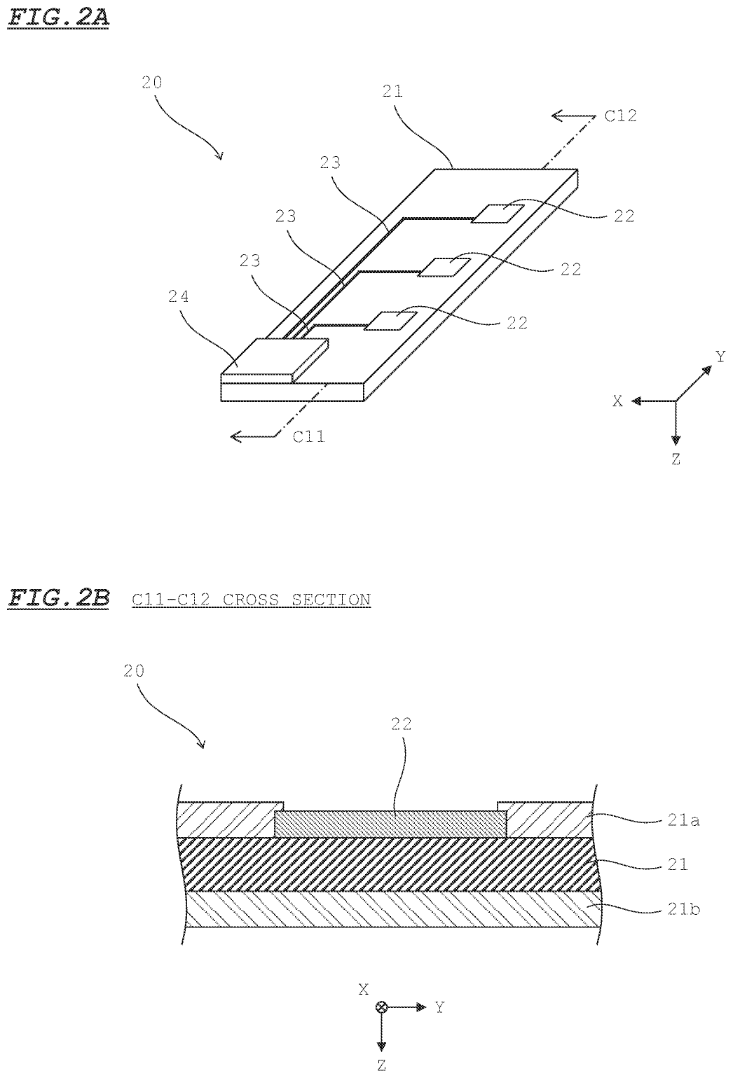

FIG. 2A is a perspective view schematically showing a configuration of a substrate 20 that is set so as to be superposed on the structure in FIG. 1B.

The substrate 20 includes a base material 21 having a plate shape, three electrodes 22, three wires 23, and a connector 24. The substrate 20 is a substrate for connecting the electrically-conductive elastic bodies 12 to an external circuit.

The base material 21 has a plate shape parallel to an X-Y plane, and is formed from an epoxy resin.

Each electrode 22 is set on the Z-axis negative side of the base material 21. The electrode 22 is an electrically-conductive member extending in the X-axis direction and the Y-axis direction, in other words, in the width direction and the length direction of the electrically-conductive elastic body 12 shown in FIGS. 1A, 1B. The face on the Z-axis negative side of the electrode 22 is parallel to an X-Y plane, and is open in the Z-axis negative direction. The electrode 22 is formed from an electrically-conductive metal material such as Au (gold), Ag (silver), or Cu (copper), for example. In Embodiment 1, the electrode 22 is formed from Cu (copper). The three electrodes 22 are arranged with a predetermined interval therebetween along the Y-axis direction. The pitch in the Y-axis direction of the three electrodes 22 is similar to the pitch in the Y-axis direction of the three electrically-conductive elastic bodies 12.

In Embodiment 1, the length in the Y-axis direction of each electrode 22 is 6 mm, for example, and the length in the X-axis direction of the electrode 22 is 4 mm, for example.

Each wire 23 is set on the face on the Z-axis negative side of the base material 21. Each wire 23 is drawn from a corresponding electrode 22, and electrically connects the electrode 22 and the connector 24 to each other.

The connector 24 is set on the face on the Z-axis negative side of the base material 21. The three wires 23 are connected to the connector 24, and an electrically-conductive member 41 (see FIG. 6B) of each conductor wire 13a described later is connected to the connector 24 during assembly of the load sensor 1. The connector 24 is a connector for connecting the load sensor 1 to an external circuit.

FIG. 2B is a diagram schematically showing a C11-C12 cross section obtained by cutting the substrate 20 along a plane parallel to a Y-Z plane passing through the centers of the electrodes 22 in FIG. 2A.

The base material 21 includes two resists 21a, 21b sandwiching the base material 21 in the up-down direction. The resist 21a, 21b is applied to the base material 21 in order to fix the electrodes 22 and the wires 23 disposed on the base material 21, and protect the wires 23.

During production of the substrate 20, a pattern of the electrodes 22 and the wires 23 is disposed on the face on the z-axis negative side of the base material 21, and the resist 21a is applied, excluding the positions of the electrodes 22. Accordingly, as shown in FIG. 2B, in a state where most of the face on the z-axis negative side of each electrode 22 is open in the Z-axis negative direction, the periphery of the electrode 22 is fixed to the base material 21 by the resist 21a. In addition, the resist 21b is applied on the face on the Z-axis positive side of the base material 21, and the connector 24 is set on the base material 21. In this manner, the substrate 20 is completed.

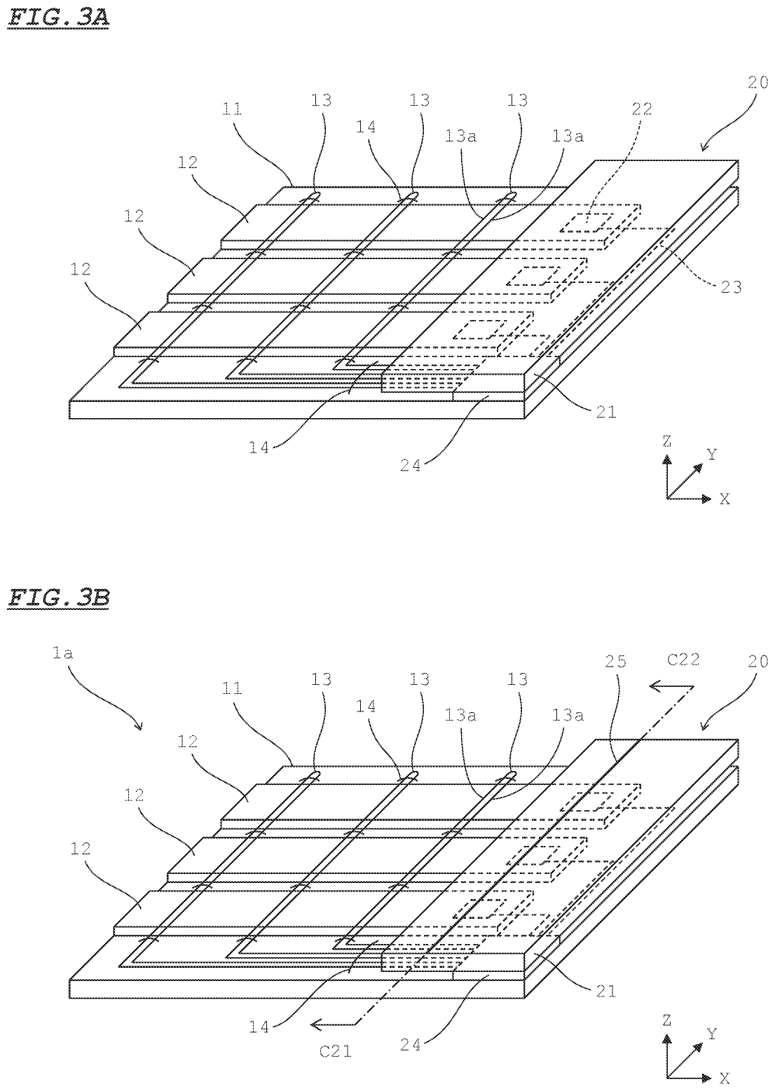

FIG. 3A is a perspective view schematically showing a state where the substrate 20 in FIG. 2A is placed on the structure in FIG. 1B.

The substrate 20 in FIG. 2A is placed upside down, from above (the Z-axis positive side) the structure in FIG. 1B. Accordingly, the three electrodes 22 of the substrate 20 respectively face the upper faces of the three electrically-conductive elastic bodies 12 disposed on the base member 11. In addition, end portions of the three pairs of conductor wires 13 are connected by soldering to the connector 24 of the substrate 20.

FIG. 3B is a perspective view schematically showing a state where a thread 25 for fixing the substrate 20 is sewn to the structure in FIG. 3A.

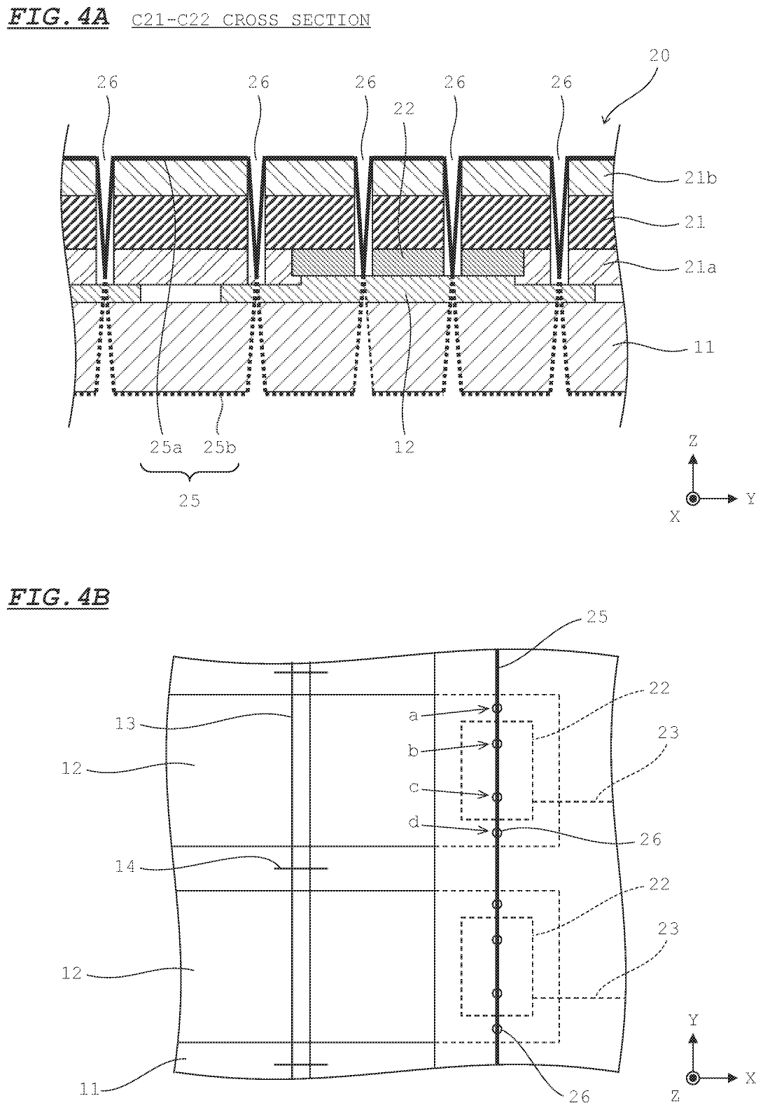

The thread 25 is sewn along the Y-axis direction so as to pass immediately above the three electrodes 22 of the substrate 20. The thread 25 is implemented by a chemical fiber, a natural fiber, a mixed fiber of the chemical fiber and the natural fiber, or the like, for example. In the substrate 20, holes 26 (see FIG. 4A) are formed in advance along a straight line passing through the centers of the electrodes 22 and extending in the Y-axis direction, and the thread 25 is sewn through the holes 26. The thread 25 is set to the structure in FIG. 3A, whereby the substrate 20 is fixed to the base member 11. In this manner, the structure 1a shown in FIG. 3B is completed.

FIG. 4A is a diagram schematically showing a C21-C22 cross section obtained by cutting the structure 1a in FIG. 3B along a plane parallel to a Y-Z plane passing through the position of the thread 25 in FIG. 3B.

In the substrate 20, a plurality of the holes 26 penetrating the substrate 20 in the up-down direction are formed along the Y-axis direction. In a case of a hole 26 at a position other than that of an electrode 22, the hole 26 is formed so as to penetrate the base material 21 and the resists 21a, 21b in the Z-axis direction. In a case of a hole 26 at the position of an electrode 22, the hole 26 is formed so as to penetrate the base material 21, the resist 21b, and the electrode 22 in the Z-axis direction.

In Embodiment 1, the thread 25 is sewn to the substrate 20 by machine sewing. In this case, the thread 25 is composed of a needle thread 25a and a bobbin thread 25b, and the needle thread 25a and the bobbin thread 25b are connected to each other in the vicinity of the center in the up-down direction of the substrate 20, the electrically-conductive elastic body 12, and the base member 11. The base member 11 and the electrically-conductive elastic body 12 are penetrated by a needle used in sewing by the thread 25. When the needle thread 25a and the bobbin thread 25b are sewn by machine sewing from the upper side and the lower side in this manner, the substrate 20 and the base member 11 are pressed to each other by the needle thread 25a and the bobbin thread 25b. At this time, the substrate 20 is fixed to the base member 11 in a state where the electrode 22 is pressed against a surface of the electrically-conductive elastic body 12. Accordingly, the electrode 22 and the electrically-conductive elastic body 12 are electrically connected to each other.

FIG. 4B is a diagram schematically showing the positions of the holes 26 and the order of sewing of the thread 25.

The holes 26 are formed along a straight line passing through the centers of the electrodes 22 and extending in the Y-axis direction. As shown in FIG. 4A, the thread 25 is set by machine sewing through the holes 26. Here, when holes 26 in the vicinity of an electrode 22 are referred to as “a” to “d” in order from the Y-axis positive side, the thread 25 (the needle thread 25a and the bobbin thread 25b) is sewn in the order of “a” to “d” shown in FIG. 4A. Further, sewing of the thread 25 is continuously performed on an adjacent electrode 22.

The holes 26 provided in the substrate 20 need not necessarily be formed along a straight line extending in the Y-axis direction as shown in FIGS. 4A, 4B, and may be formed at other positions.

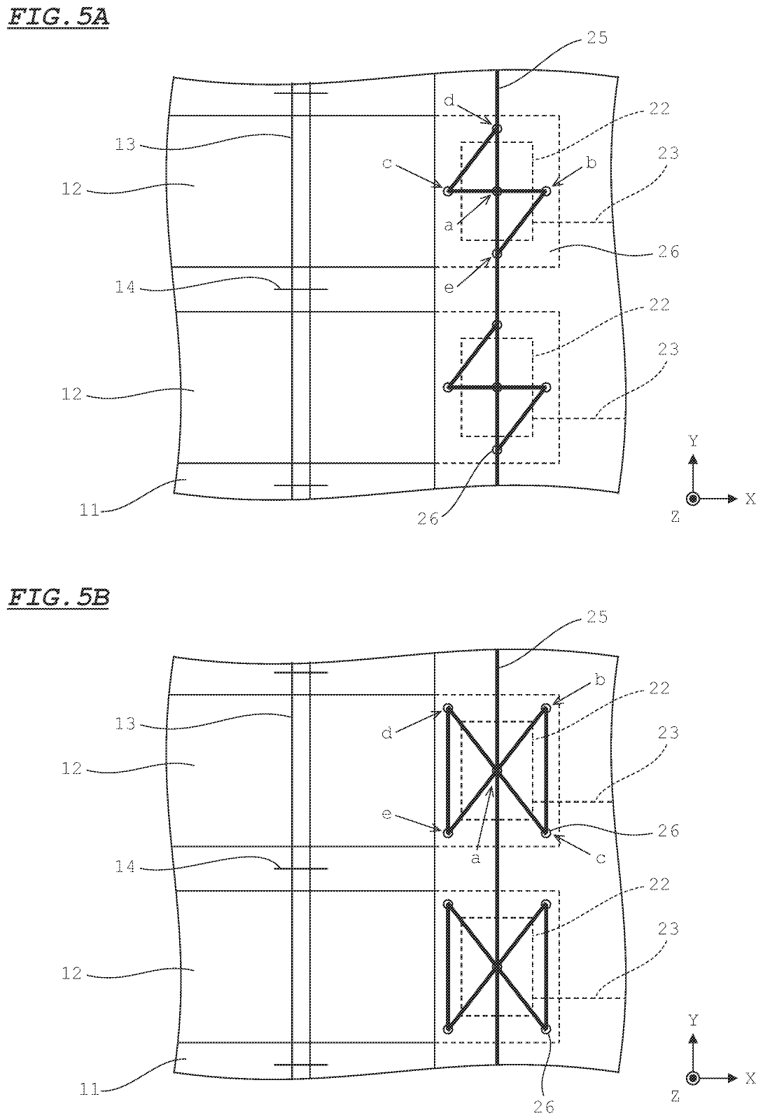

In modifications shown in FIGS. 5A, 5B, five holes 26 are formed in the vicinity of an electrode 22, as indicated by “a” to “e”.

In a case of the modification shown in FIG. 5A, “a” is a hole 26 formed at the center position of the electrode 22. to “e” are holes 26 that are present, with respect to the hole 26 “a”, on the X-axis positive side, the X-axis negative side, the Y-axis positive side, and the Y-axis negative side, respectively, and that are formed outside the electrode 22 and within the range of the electrically-conductive elastic body 12. When the sewing by the thread 25 is performed from the Y-axis positive side toward the Y-axis negative side of the electrode 22, the thread 25 (the needle thread 25a and the bobbin thread 25b) is sewn in the order of “d”, “a”, “e”, “b”, “a”, “c”, “d”, “a”, and “e”.

In a case of the modification shown in FIG. 5B, “a” is a hole 26 formed at the center position of the electrode 22. “b” to “e” are holes 26 formed outside the electrode 22 and within the range of the electrically-conductive elastic body 12. “b” is a hole 26 on the X-axis positive side and the Y-axis positive side with respect to the hole 26 “a”. “c” is a hole 26 on the X-axis positive side and the Y-axis negative side with respect to the hole 26 “a”. “d” is a hole 26 on the X-axis negative side and the Y-axis positive side respect to the hole 26 “a”. “e” is a hole 26 on the X-axis negative side and the Y-axis negative side with respect to the hole 26 “a”. When the sewing by the thread 25 is performed from the Y-axis positive side toward the Y-axis negative side of the electrode 22, the thread 25 (the needle thread 25a and the bobbin thread 25b) is sewn in the order of “a”, “c”, “b”, “a”, “e”, “d”, and “a”.

FIG. 6A is a perspective view schematically showing a state where a base member 31 is set to the structure 1a shown in FIG. 3B.

As shown in FIG. 6A, the base member 31 is set from above the structure 1a shown in FIG. 3B. The base member 31 is an insulative member. The base member 31 is a plate-shaped member having flat planes on the Z-axis positive side and the Z-axis negative side, and the planes on the Z-axis positive side and the Z-axis negative side of the base member 31 are parallel to an X-Y plane. The base member 31 is a resin material of at least one type selected from the group consisting of polyethylene terephthalate, polycarbonate, polyimide, and the like, for example. The base member 31 is disposed so as to be adjacent, on the X-axis negative side, to the substrate 20. In an X-Y plane, the total size of the base member 31 and the substrate 20 is substantially the same as the size of the base member 11.

Four corners of the base member 31 are connected to the base member 11 by a silicone rubber-based adhesive, a thread, or the like, whereby the base member 31 is fixed to the base member 11. Accordingly, the three pairs of conductor wires 13 are sandwiched by the three electrically-conductive elastic bodies 12 and the base member 31. In this manner, the load sensor 1 is completed as shown in FIG. 6A.

FIG. 6B is a diagram schematically showing a cross section C31-C32 obtained by cutting the load sensor 1 along a plane parallel to an X-Z plane passing through the centers of the electrodes 22. FIG. 6B shows the vicinity of an end portion on the X-axis positive side of the electrically-conductive elastic body 12.

In the vicinity of the end portion on the X-axis positive side of the electrically-conductive elastic body 12, the electrode 22 is pressed against the upper face of the electrically-conductive elastic body 12. At this time, the electrically-conductive elastic body 12 having elasticity enters up to the lower face of the electrode 22 surrounded by the resist 21a, and the electrode 22 and the electrically-conductive elastic body 12 adhere to each other. Accordingly, the electrically-conductive elastic body 12 and the electrode 22 are electrically connected to each other.

The conductor wire 13a is composed of the electrically-conductive member 41 and a dielectric body 42 formed on the electrically-conductive member 41.

The electrically-conductive member 41 is a wire member having a linear shape. The electrically-conductive member 41 is formed from an electrically-conductive metal material, for example. Other than this, the electrically-conductive member 41 may be composed of a core wire made of glass, and an electrically-conductive layer formed on the surface of the core wire. Alternatively, the electrically-conductive member 41 may be composed of a core wire made of resin, and an electrically-conductive layer formed on the surface of the core wire, for example. For example, as the electrically-conductive member 41, a valve action metal such as aluminum (Al), titanium (Ti), tantalum (Ta), niobium (Nb), zirconium (Zr), or hafnium (Hf); tungsten (W); molybdenum (Mo); copper (Cu); nickel (Ni); silver (Ag); gold (Au); or the like is used.

The dielectric body 42 has an electric insulation property, and is formed from a resin material, a ceramic material, a metal oxide material, or the like, for example. The dielectric body 42 may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 42 may be a metal oxide material of at least one selected from the group consisting of Al₂O₃, Ta₂O₅, and the like.

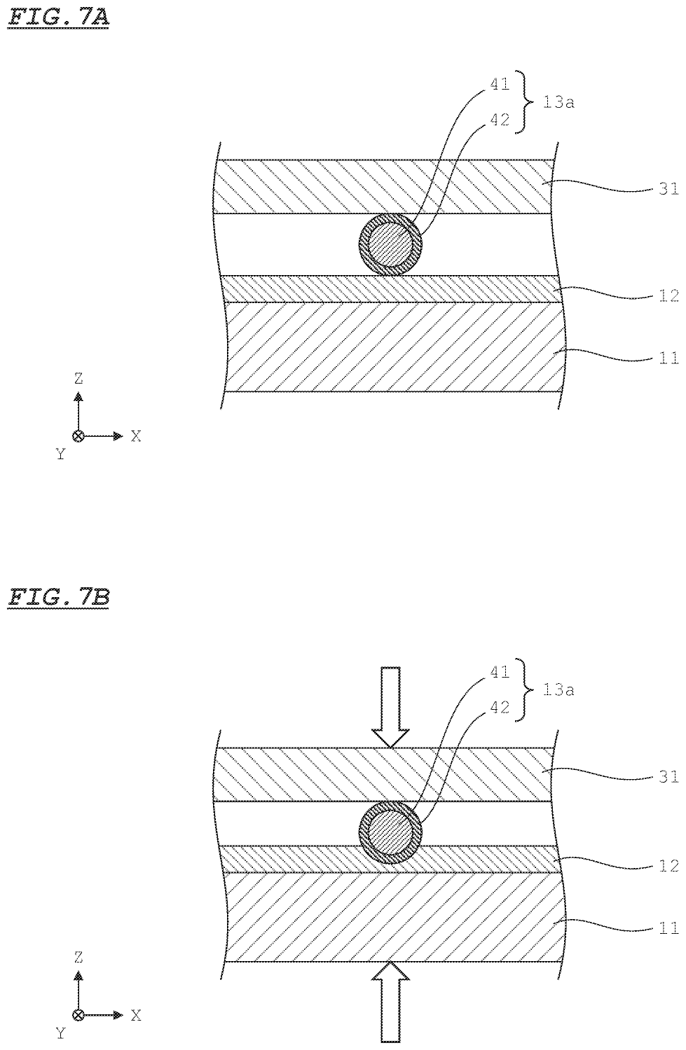

FIGS. 7A, 7B are each a cross-sectional view schematically showing surroundings of a conductor wire 13a viewed in the Y-axis positive direction. FIG. 7A shows a state where no load is applied, and FIG. 7B shows a state where loads are applied.

As shown in FIG. 7A, when no load is applied, the force applied between the electrically-conductive elastic body 12 and the conductor wire 13a is substantially zero. From this state, as shown in FIG. 7B, when a load is applied in the upward direction to the lower face of the base member 11 and a load is applied in the downward direction to the upper face of the base member 31, the electrically-conductive elastic body 12 is deformed by the conductor wire 13a.

As shown in FIG. 7B, when loads are applied, the conductor wire 13a is brought close to the electrically-conductive elastic body 12 so as to be wrapped by the electrically-conductive elastic body 12, and the contact area between the conductor wire 13a and the electrically-conductive elastic body 12 increases. Accordingly, the capacitance between the electrically-conductive member 41 and the electrically-conductive elastic body 12 changes. Then, the capacitance in the region of a pair of conductor wires 13 (two conductor wires 13a) is detected, whereby the load applied to this region is calculated.

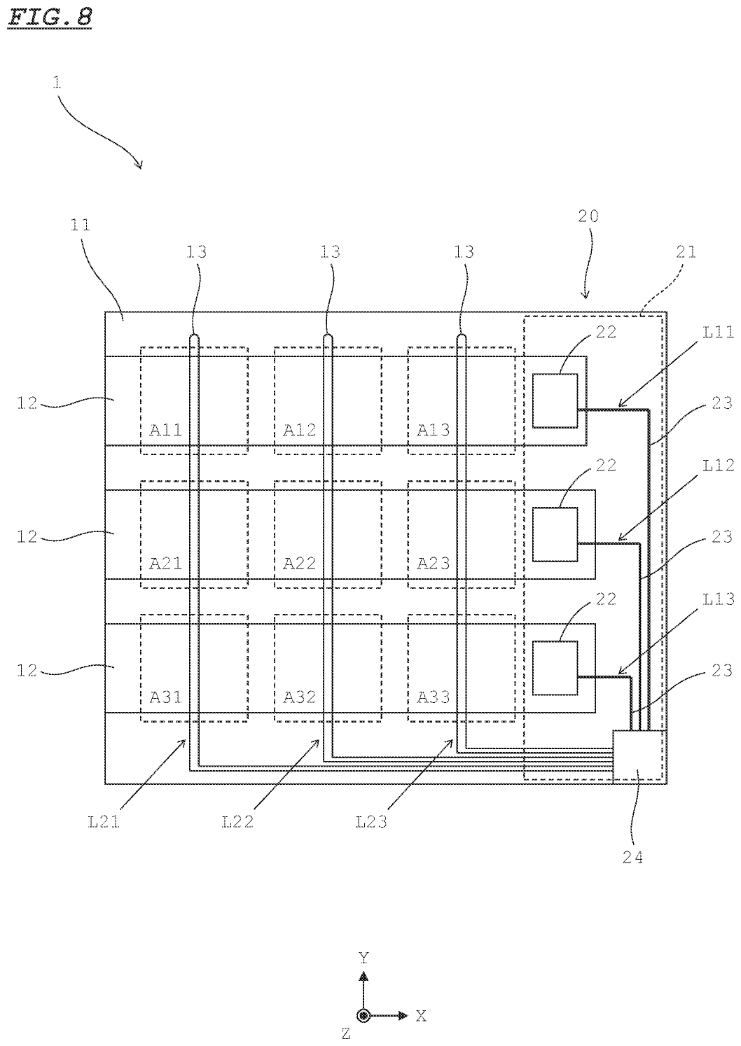

FIG. 8 is a plan view schematically showing the inside of the load sensor 1 viewed in the Z-axis negative direction. In FIG. 8, for convenience, the threads 14 are not shown, and the base member 31 and the base material 21 of the substrate 20 are shown in a transparent manner.

In a measurement region of the load sensor 1, nine sensor parts arranged in the X-axis direction and the Y-axis direction are set. Specifically, nine regions obtained by dividing the measurement region into three in the X-axis direction and dividing the measurement region into three in the Y-axis direction are assigned as the nine sensor parts. The boundary of each sensor part is in contact with the boundary of a sensor part adjacent thereto. The nine sensor parts correspond to nine positions where the electrically-conductive elastic bodies 12 and the pairs of conductor wires 13 cross each other. At these nine positions, nine sensor parts A11, A12, A13, A21, A22, A23, A31, A32, A33 in each of which capacitance changes in accordance with a load are formed.

Each sensor part includes an electrically-conductive elastic body 12, and a pair of conductor wires 13, and the pair of conductor wires 13 forms one pole (e.g., positive pole) for capacitance, and the electrically-conductive elastic body 12 forms the other pole (e.g., negative pole) for capacitance. That is, the electrically-conductive member 41 (see FIG. 6B) in the pair of conductor wires 13 forms one electrode of the load sensor 1 (capacitance-type load sensor), the electrically-conductive elastic body 12 forms the other electrode of the load sensor 1 (capacitance-type load sensor), and the dielectric body 42 (see FIG. 6B) in the pair of conductor wires 13 corresponds to a dielectric body that defines capacitance in the load sensor 1 (capacitance-type load sensor).

When a load is applied in the Z-axis direction to each sensor part, the pair of conductor wires 13 is wrapped by the electrically-conductive elastic body 12 due to the load. Accordingly, the contact area between the pair of conductor wires 13 and the electrically-conductive elastic body 12 changes, and the capacitance between the electrically-conductive member 41 in the pair of conductor wires 13 and the electrically-conductive elastic body 12 changes.

In FIG. 8, the wires 23 drawn from the three electrodes 22 are indicated as lines L11, L12, L13, and the electrically-conductive members 41 in the three pairs of conductor wires 13 are indicated as lines L21, L22, L23. The positions at which the electrically-conductive elastic body 12 connected to the line L11 crosses the lines L21, L22, L23 are the sensor parts A11, A12, A13, respectively. The positions at which the electrically-conductive elastic body 12 connected to the line L12 crosses the lines L21, L22, L23 are the sensor parts A21, A22, A23, respectively. The positions at which the electrically-conductive elastic body 12 connected to the line L13 crosses the lines L21, L22, L23 are the sensor parts A31, A32, A33, respectively.

When a load is applied to the sensor part A11, the contact area between the pair of conductor wires 13 and the electrically-conductive elastic body 12 increases in the sensor part A11. Therefore, when the capacitance between the line L11 and the line L21 is detected, the load applied to the sensor part A11 can be calculated. Similarly, in another sensor part as well, when the capacitance between two lines crossing each other in the other sensor part is detected, the load applied to the other sensor part can be calculated.

<Effects of Embodiment 1>

According to Embodiment 1, the following effects are exhibited.

Each electrode 22 extends in the width direction (the Y-axis direction) and the length direction (the X-axis direction) of a corresponding electrically-conductive elastic body 12 and the substrate 20 is fixed to the base member 11 in a state where the electrode 22 is pressed against the surface of the electrically-conductive elastic body 12. According to this configuration, since the electrode 22 and the electrically-conductive elastic body 12 are in surface contact with each other, the contact area between the electrode 22 and the electrically-conductive elastic body 12 is increased. Therefore, the electric resistance at the interface between the electrode 22 and the electrically-conductive elastic body 12 can be suppressed to a low level, and the capacitance according to the load can be accurately detected.

As shown in FIG. 4B to FIG. 5B, the substrate 20 is fixed to the base member 11 by the thread 25 (connection tool) in the vicinity of each electrode 22. The vicinity of the electrode 22 is a range that includes, in a plan view, the range of the electrode 22, and the range where the electrically-conductive elastic body 12 and the substrate 20 overlap each other. According to this configuration, a fastening force applied by the thread 25 is applied to the vicinity of the electrode 22, and thus, the electrode 22 and the electrically-conductive elastic body 12 can be caused to be in strong contact with each other. Therefore, the electrode 22 and the electrically-conductive elastic body 12 can be more assuredly adhered to each other, and the electric resistance between the electrode 22 and the electrically-conductive elastic body 12 can be effectively suppressed.

In order to fix the substrate 20 to the base member 11, the thread 25 is used as a connection tool. Thus, the contact position between each electrode 22 and a corresponding electrically-conductive elastic body 12 can be fixed in a simple and strong manner. Therefore, while the mounting step of the substrate 20 to the base member 11 is simplified, the contact resistance between the electrode 22 and the electrically-conductive elastic body 12 can be effectively suppressed. Further, as described with reference to FIG. 4B to FIG. 5B, the thread 25 is sewn through the holes 26 in order, and the thread 25 is continuously sewn also to an adjacent electrode 22. Therefore, the steps of sewing the thread 25 can be reduced. Further, as shown in FIG. 4A, since all of the region between adjacent holes 26 is pressed by the thread 25, the substrate 20 can be more assuredly fixed to the base member 11 than in a case where the thread 25 is partially sewn.

As shown in FIG. 4B to FIG. 5B, the substrate 20 is fixed to the base member 11 by the thread 25 at positions in point symmetry with respect to the center in an X-Y plane of each electrode 22. According to this configuration, the electrode 22 is pressed against the electrically-conductive elastic body 12 in good balance, and thus, connection between the electrode 22 and the electrically-conductive elastic body 12 is ensured.

In order to further ensure the connection, an eyelet or a jig may be added as an additional connection tool. In this case, the additional connection tool is set so as to increase the force by which the electrode 22 is pressed against the electrically-conductive elastic body 12. According to this configuration, displacement due to expansion and contraction of a thread or rubber can be reduced, and thus, connection between the electrode 22 and the electrically-conductive elastic body 12 can be more ensured.

The electrically-conductive members 41, as well as the electrodes 22, are connected to the connector 24 of the substrate 20. According to this configuration, by merely connecting the connector 24 of the substrate 20 to an external circuit provided in an external device or the like, it is possible to supply the external circuit with all signals necessary for load detection.

As shown in FIGS. 3A, 3B, the substrate 20 has a plurality of electrodes 22 to be respectively superposed on a plurality of electrically-conductive elastic bodies 12. According to this configuration, by merely mounting a single substrate 20 to the base member 11, it is possible to connect the plurality of electrodes 22 to the plurality of electrically-conductive elastic bodies 12, respectively.

<Modification of Embodiment 1>

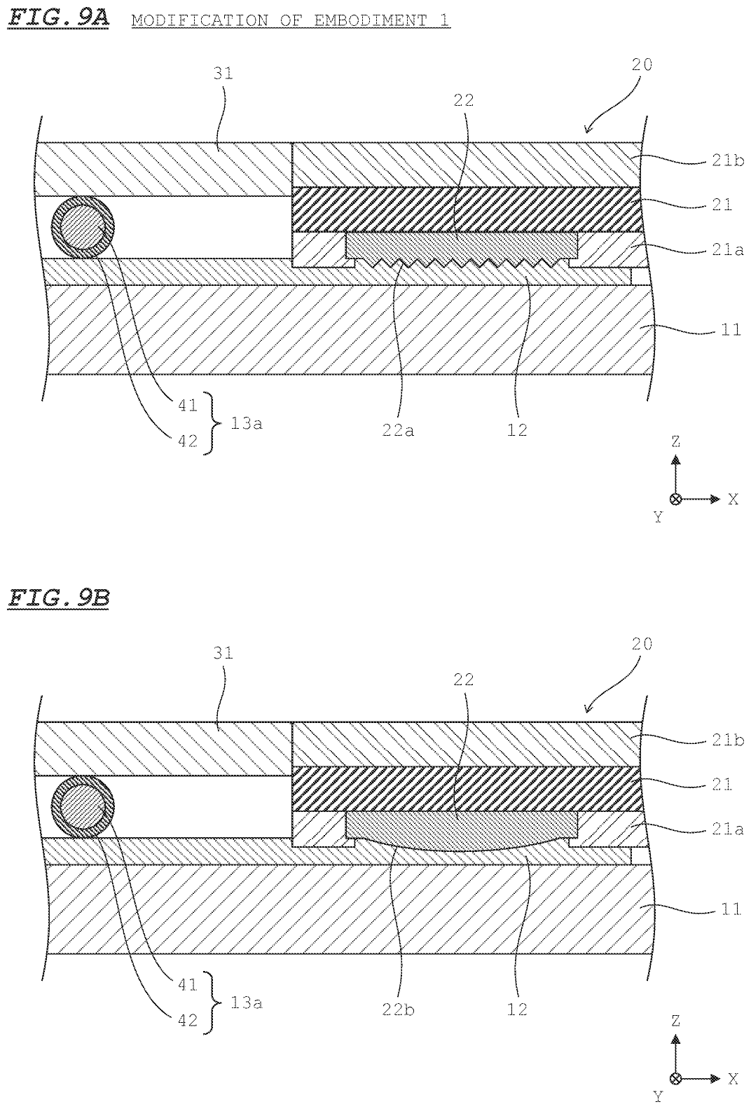

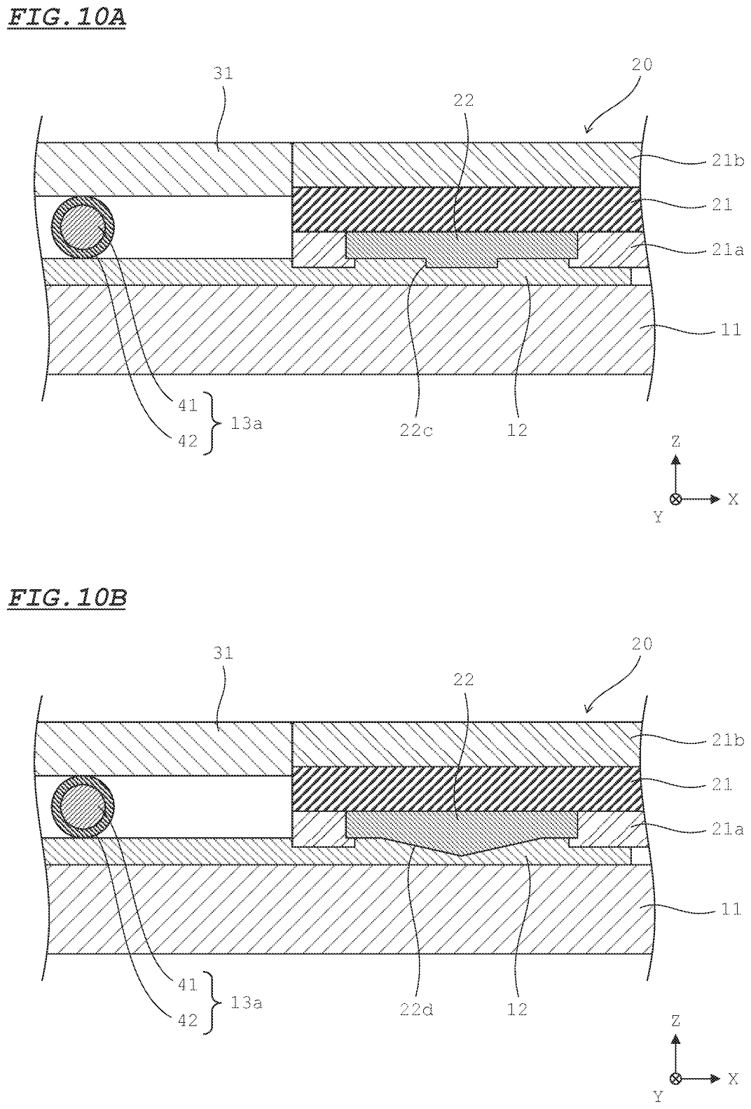

In Embodiment 1 above, each electrode 22 has a flat plate shape, and thus, the lower face (the surface on the Z-axis negative side) of the electrode 22 in contact with the electrically-conductive elastic body 12 is a flat surface parallel to an X-Y plane. However, the lower face of the electrode 22 need not necessarily be a flat surface, and may have another shape described below with reference to FIG. 9A to FIG. 10B, for example.

FIG. 9A to FIG. 10B are each a diagram schematically showing a cross section obtained by cutting the load sensor 1 along a plane parallel to an X-Z plane passing through the center of an electrode 22, according to modifications of Embodiment 1.

In the example shown in FIG. 9A, the electrode 22 has irregularities 22a on the lower face thereof. The irregularities 22a are formed by roughening the lower face of the electrode 22 having a flat plate shape. For example, the lower face of the electrode 22 parallel to an X-Y plane is treated with a predetermined solution, whereby the fine irregularities 22a are formed on the lower face of the electrode 22. As a result of the substrate 20 being pressed against the electrically-conductive elastic body 12 and fixed to the base member 11, the electrically-conductive elastic body 12 enters between gaps of the irregularities 22a, whereby the contact area between the electrode 22 and the electrically-conductive elastic body 12 is increased, when compared with that in FIG. 6B.

In the example shown in FIG. 9B, the lower face of the electrode 22 is a curved surface 22b protruding, in a curved surface shape (dome shape), to the electrically-conductive elastic body 12 side (the Z-axis negative direction) in the vicinity of the center of the electrode 22. The curved surface 22b is formed by performing etching on the lower face of the electrode 22 having a flat plate shape, for example. In this case as well, the contact area between the electrode 22 and the electrically-conductive elastic body 12 is increased, when compared with that in FIG. 6B.

In the example shown in FIG. 10A, the lower face of the electrode 22 is a protruding face 22c protruding, in a step-like manner, to the electrically-conductive elastic body 12 side (the Z-axis negative direction) in the vicinity of the center of the electrode 22. The protruding face 22c has a circular shape, when viewed in the Z-axis direction. The protruding face 22c is shaped by performing etching on the lower face of the electrode 22 having a flat plate shape, for example. In this case as well, the contact area between the electrode 22 and the electrically-conductive elastic body 12 is increased, when compared with that in FIG. 6B.

The shape of the protruding face 22c may be a ridge shape, that is, a projecting shape having a width similar to that of the electrode 22 in the Y-axis direction. The shape of the protruding face 22c may be a ridge shape extending in the X-axis direction. The shape of the protruding face 22c may be a rectangular shape in a plan view. The number of steps formed by the protruding face 22c is not limited to 2 as in FIG. 10A, and may be 3 or greater.

In the example shown in FIG. 10B, the lower face of the electrode 22 is a protruding face 22d protruding, in a conical shape, to the electrically-conductive elastic body 12 side (the Z-axis negative direction) in the vicinity of the center of the electrode 22. The protruding face 22d is shaped by performing etching on the lower face of the electrode 22 having a flat plate shape, for example. In this case as well, the contact area between the electrode 22 and the electrically-conductive elastic body 12 is increased, when compared with that in FIG. 6B.

The shape of the protruding face 22d may be a ridge shape, that is, a shape having a width similar to that of the electrode 22 in the Y-axis direction. The protruding face 22d may have a ridge shape extending in the X-axis direction.

<Effects of modifications of Embodiment 1>

According to the modifications of Embodiment 1, the following effects are exhibited.

As shown in FIG. 9A, when the electrode 22 has the irregularities 22a on a surface thereof, the contact area between the electrode 22 and the electrically-conductive elastic body 12 is increased, when compared with a case where the surface is a flat surface. Therefore, the resistance value in the connection portion between the electrode 22 and the electrically-conductive elastic body 12 can be suppressed to a low level.

As shown in FIG. 9B to FIG. 10B, when a surface of the electrode 22 protrudes to the electrically-conductive elastic body 12 side, the contact area between the electrode 22 and the electrically-conductive elastic body 12 is increased, when compared with a case where the surface is a flat surface. Therefore, the resistance value in the connection portion between the electrode 22 and the electrically-conductive elastic body 12 can be suppressed to a low level. Further, when the substrate 20 is fixed to the base member 11, the surface of the electrode 22 is more strongly pressed against the electrically-conductive elastic body 12. Therefore, the adhesion between the electrode 22 and the electrically-conductive elastic body 12 can be enhanced, and the contact resistance between the electrode 22 and the electrically-conductive elastic body 12 can be decreased.

As shown in FIG. 9B, when a surface of the electrode 22 protrudes in a curved surface shape, the pressing force of the electrode 22 against the electrically-conductive elastic body 12 smoothly changes along the curved surface. Therefore, the electrode 22 can be stably adhered to the electrically-conductive elastic body 12.

As shown in FIG. 10A, when a surface of the electrode 22 protrudes in a step-like manner, the surface protruding in a step-like manner can be strongly pressed against the electrically-conductive elastic body 12. Therefore, the adhesion between the surface and the electrically-conductive elastic body 12 can be enhanced.

As shown in FIG. 10B, when the cross-sectional shape of a surface of the electrode 22 is a triangular shape, the electrode 22 can be stably adhered to the electrically-conductive elastic body 12 as in the case of FIG. 9B, and the adhesion between the surface of the electrode 22 and the electrically-conductive elastic body 12 can be enhanced as in the case of FIG. 10A.

In the configurations in FIG. 9B to FIG. 10B, the curved surface 22b and the protruding faces 22c, 22d are formed as a part of the electrode 22. However, when the electrode 22 is implemented by a first electrically-conductive material, the curved surface 22b and the protruding faces 22c, 22d may each be implemented by a second electrically-conductive material set on the lower face of the first electrically-conductive material having a flat plate shape. In this case, the lower face of the second electrically-conductive material is formed so as to have a shape similar to that of the curved surface 22b, the protruding face 22c, or the protruding face 22d, and the upper face of the second electrically-conductive material is set to be parallel to an X-Y plane. Such a second electrically-conductive material is set on the lower face of the first electrically-conductive material having a flat plate shape.

When the electrode 22 is composed of the first electrically-conductive material and the second electrically-conductive material as described above, the first electrically-conductive material and the second electrically-conductive material may be formed from materials different from each other, or may be formed from the same material. In this case, the second electrically-conductive material in a paste state is solidified at the lower face of the first electrically-conductive material, or a tape obtained by applying an adhesive to the second electrically-conductive material in a thin film shape is attached to the lower face of the first electrically-conductive material, whereby the second electrically-conductive material is set. In addition to the first electrically-conductive material and the second electrically-conductive material, another electrically-conductive material may be further superposed.

### Embodiment 2

In the modifications of Embodiment 1 above, the contact area in the connection portion between the electrode 22 and the electrically-conductive elastic body 12 is increased, whereby the resistance value in the connection portion is suppressed to a low level. In contrast, in Embodiment 2, a material having a higher electric conductivity is disposed at the connection portion, whereby the resistance value in the connection portion is suppressed to a low level.

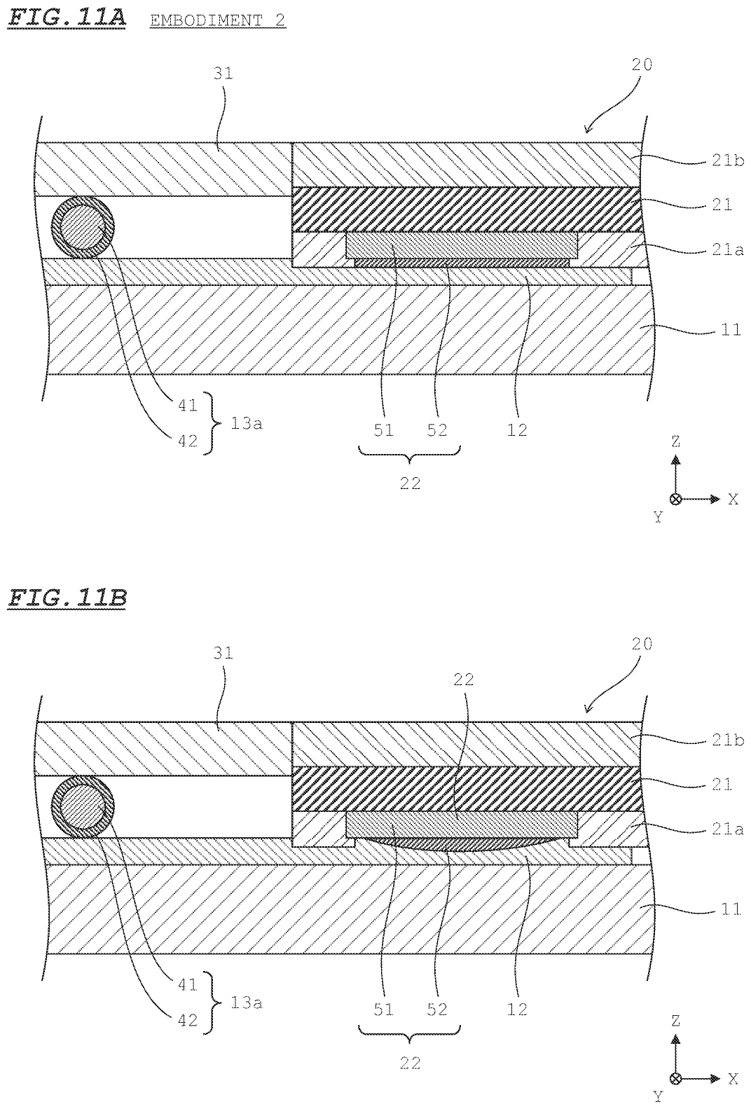

FIG. 11A is a diagram schematically showing a cross section obtained by cutting the load sensor 1 along a plane parallel to an X-Z plane passing through the center of an electrode 22, according to Embodiment 2.

In Embodiment 2, the electrode 22 is composed of a first electrically-conductive material 51 and a second electrically-conductive material 52. The first electrically-conductive material 51 has a flat plate shape, similar to the electrode 22 of Embodiment 1 above. The second electrically-conductive material 52 is formed from a material having an electric conductivity higher than that of the first electrically-conductive material 51. The first electrically-conductive material 51 is formed from Cu (copper), for example, and the second electrically-conductive material 52 is formed from Ag (silver), for example. The second electrically-conductive material 52 is formed, using a silver paste, on the lower face of the first electrically-conductive material 51, for example. During production of the substrate 20, the second electrically-conductive material 52 is disposed on the lower face of the first electrically-conductive material 51 having a flat plate shape.

The shape of the second electrically-conductive material 52 is not limited to a flat plate shape as shown in FIG. 11A. For example, as shown in FIG. 11B, the second electrically-conductive material 52 may be formed so as to protrude, in a curved surface shape (dome shape), to the electrically-conductive elastic body 12 side (the Z-axis negative direction) in the vicinity of the center of the electrode 22. Further, the second electrically-conductive material 52 may protrude in another shape, and may protrude in a shape similar to those in FIGS. 10A, 10B, for example.

<Effects of Embodiment 2>

According to Embodiment 2, the following effects are exhibited.

As shown in FIGS. 11A, 11B, the second electrically-conductive material 52 is disposed on the obverse side of the first electrically-conductive material 51, is exposed to outside (the electrically-conductive elastic body 12 side), and has an electric conductivity higher than that of the first electrically-conductive material 51. When the second electrically-conductive material 52 is disposed between the first electrically-conductive material 51 and the electrically-conductive elastic body 12 in this manner, the electric resistance at the interface between the electrode 22 and the electrically-conductive elastic body 12 can be effectively suppressed.

As shown in FIG. 11B, a surface of the electrode 22 protrudes in a curved surface shape to the electrically-conductive elastic body 12 side, and the portion protruding in the curved surface shape of the electrode 22 is implemented by the second electrically-conductive material 52. According to this configuration, the contact area between the electrode 22 and the electrically-conductive elastic body 12 is increased, when compared with that in FIG. 11A. Therefore, the resistance value in the connection portion between the electrode 22 and the electrically-conductive elastic body 12 can be further suppressed to a low level. Since the lower face of the electrode 22 (the second electrically-conductive material 52) is formed in a curved surface shape as in the case of FIG. 9B, the pressing force of the electrode 22 against the electrically-conductive elastic body 12 smoothly changes along the curved surface. Therefore, the electrode 22 can be stably adhered to the electrically-conductive elastic body 12. Since the second electrically-conductive material 52 having a high electric conductivity is disposed between the first electrically-conductive material 51 and the electrically-conductive elastic body 12 as in the case of FIG. 11A, the contact resistance between the surface in a curved surface shape that allows enhanced adhesion and the electrically-conductive elastic body 12 can be suppressed to a low level. Therefore, the resistance value between the electrode 22 and the electrically-conductive elastic body 12 can be further effectively decreased.

### Embodiment 3

In Embodiment 2, the electric conductivity on the electrode 22 side is increased, whereby the resistance value in the connection portion between the electrode 22 and the electrically-conductive elastic body 12 is suppressed to a low level. However, in Embodiment 3, the electric conductivity on the electrically-conductive elastic body 12 side is increased, whereby the resistance value in the connection portion between the electrode 22 and the electrically-conductive elastic body 12 is suppressed to a low level.

In Embodiment 3, the electrically-conductive elastic body 12 is composed of a first electrically-conductive elastic body 12a and a second electrically-conductive elastic body 12b. Similar to Embodiments 1, 2 above, the first electrically-conductive elastic body 12a includes C (carbon) as an electrically-conductive filler and the second electrically-conductive elastic body 12b includes Ag (silver) as an electrically-conductive filler. Accordingly, the second electrically-conductive elastic body 12b has an electric conductivity higher than that of the first electrically-conductive elastic body 12a.

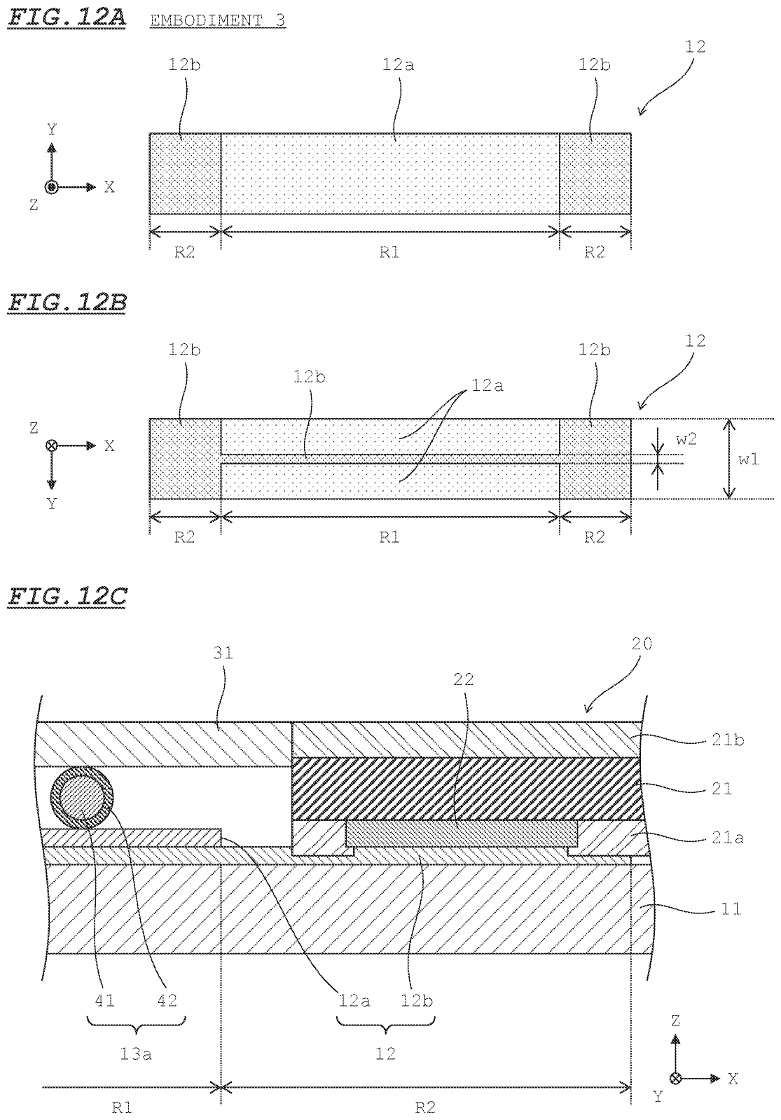

FIGS. 12A, 12B are each a plan view schematically showing a configuration of the electrically-conductive elastic body 12, according to Embodiment 3. FIG. 12A shows the electrically-conductive elastic body 12 viewed in the Z-axis negative direction, and FIG. 12B shows the electrically-conductive elastic body 12 viewed in the Z-axis positive direction.

As shown in FIGS. 12A, 12B, the outer shape of the electrically-conductive elastic body 12 is similar to that in Embodiments 1, 2 above. The first electrically-conductive elastic body 12a is exposed to the Z-axis positive side in a range R1 in the vicinity of the center of the electrically-conductive elastic body 12. The first electrically-conductive elastic body 12a has a length similar to that of the range R1 in the longitudinal direction (the X-axis direction) of the electrically-conductive elastic body 12. The range R1 corresponds to at least the range where one pair of conductor wires 13 are superposed.

The second electrically-conductive elastic body 12b has a length similar to that of the electrically-conductive elastic body 12 in the X-axis direction. In the range R1, the Z-axis positive side of the second electrically-conductive elastic body 12b is covered by the first electrically-conductive elastic body 12a. The second electrically-conductive elastic body 12b is exposed to the Z-axis positive side in a range R2 positioned on the outer side of the range R1 of the electrically-conductive elastic body 12. The range R2 corresponds to at least the range where the electrode 22 is superposed. A width w2 (the length in the Y-axis direction) of the second electrically-conductive elastic body 12b in the range R1 is shorter than a width w1 (the length in the Y-axis direction) of the electrically-conductive elastic body 12.

FIG. 12C is a diagram schematically showing a cross section obtained by cutting the load sensor 1 along a plane parallel to an X-Z plane passing through the center of an electrode 22, according to Embodiment 3.

At the center position in the Y-axis direction of the electrically-conductive elastic body 12, the first electrically-conductive elastic body 12a is laminated on the upper side of the second electrically-conductive elastic body 12b. The second electrically-conductive elastic body 12b is open upward in the range R2. During production of the load sensor 1, the second electrically-conductive elastic body 12b is formed on the upper face of the base member 11 by a predetermined printing method. Then, from the upper side of the second electrically-conductive elastic body 12b, the first electrically-conductive elastic body 12a is laminated by a predetermined printing method. The substrate 20 is fixed to the base member 11 such that the electrode 22 is pressed against the surface of the second electrically-conductive elastic body 12b.

<Effects of Embodiment 3>

According to Embodiment 3, the following effects are exhibited.

As shown in FIG. 12C, the second electrically-conductive elastic body 12b has an electric conductivity higher than that of the first electrically-conductive elastic body 12a, and the substrate 20 is fixed to the base member 11 such that the electrode 22 is pressed against the surface of the second electrically-conductive elastic body 12b. Accordingly, similar to Embodiment 2 above, as in the case where the second electrically-conductive material 52 is disposed between the first electrically-conductive material 51 and the electrically-conductive elastic body 12, the electric resistance at the interface between the electrode 22 and the electrically-conductive elastic body 12 can be suppressed.

As shown in FIGS. 12A, 12B, the first electrically-conductive elastic body 12a covers the second electrically-conductive elastic body 12b at least in the range R1 where the electrically-conductive member 41 is superposed, and, out of the second electrically-conductive elastic body 12b, at least the portion of the range R2 where the electrode 22 is superposed is exposed to outside (upward). In addition, the width of the second electrically-conductive elastic body 12b is smaller in the range R1 where the electrically-conductive member 41 is superposed than in the range R2 where the electrode 22 is superposed. In general, a material having a high electric conductivity is expensive. However, according to this configuration, the second electrically-conductive elastic body 12b having a high electric conductivity can be saved, and thus, the cost of the second electrically-conductive elastic body 12b can be suppressed to a low level. In general, when an elastic body includes a material having a high electric conductivity, the elastic modulus is increased (the elastic body itself becomes hard). However, according to this configuration, the width w2 of the second electrically-conductive elastic body 12b in the range R1 where the electrically-conductive member 41 is disposed is small, and thus, the elastic modulus in the range R1 can be maintained at a low level. Therefore, the capacitance can be smoothly changed according to the load.

The second electrically-conductive elastic body 12b includes Ag (silver). Accordingly, the electric resistance at the interface between the electrode 22 and the electrically-conductive elastic body 12 can be effectively suppressed.

In the electrode 22 of Embodiment 3 as well, the modifications of Embodiment 1 or the configurations of Embodiment 2 may be applied.

In a plan view, the shape of the second electrically-conductive elastic body 12b in the range R1 is not limited to the shape shown in FIGS. 12A, 12B. For example, the width w2 of the second electrically-conductive elastic body 12b in the range R1 need not necessarily be constant, and the second electrically-conductive elastic body 12b in the range R1 may be disposed in a mesh shape. The shape of the second electrically-conductive elastic body 12b in the range R2 on the X-axis negative side may be a linear shape, as in the case of the range R1. The width in the Y-axis direction of the second electrically-conductive elastic body 12b in the range R2 may be longer, or may be shorter, than that in FIGS. 12A, 12B.

### Embodiment 4

In Embodiment 1, no electrically-conductive elastic body is disposed on the base member 31. However, in Embodiment 4, an electrically-conductive elastic body is disposed on both of the base member 11 and the base member 31.

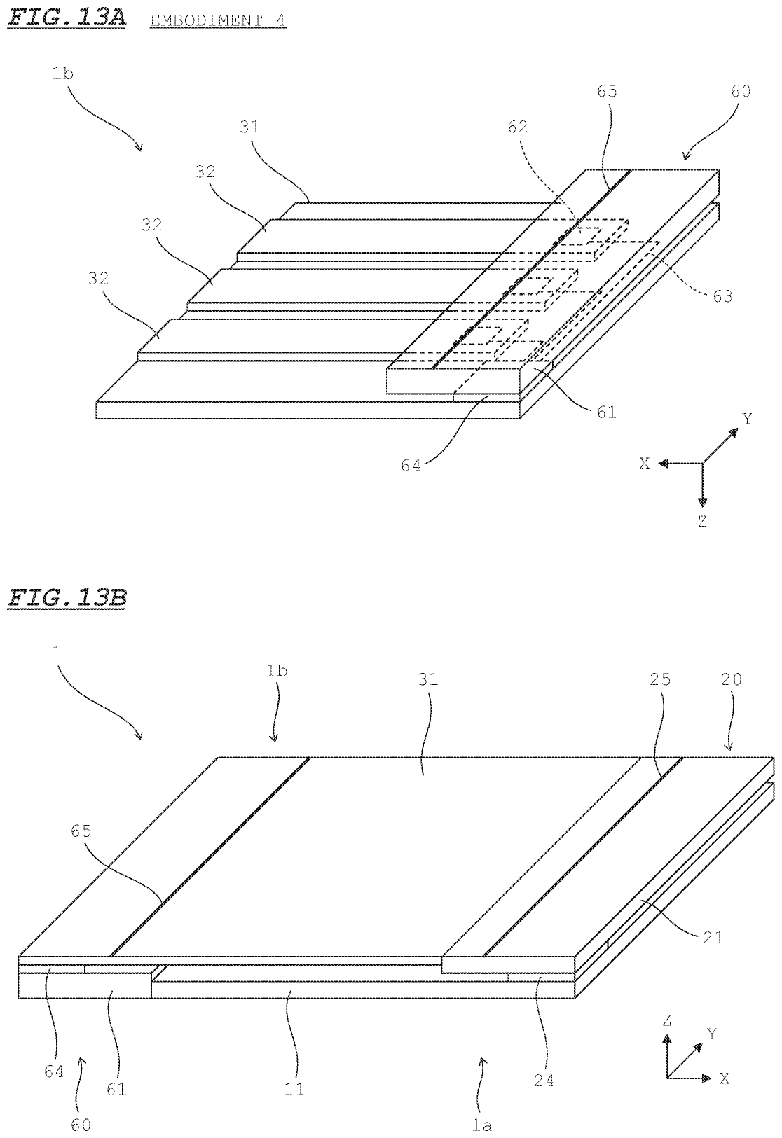

FIG. 13A is a perspective view schematically showing a configuration of a structure 1b, according to Embodiment 4.

The structure 1b has a configuration in which the pairs of conductor wires 13 and the threads 14 are eliminated from the structure 1a shown in FIG. 3B. The base member 31, electrically-conductive elastic bodies 32, a substrate 60, a base material 61, electrodes 62, wires 63, a connector 64, and a thread 65 of the structure 1b correspond to the base member 11, the electrically-conductive elastic bodies 12, the substrate 20, the base material 21, the electrodes 22, the wires 23, the connector 24, and the thread 25, of the structure 1a, respectively.

That is, three electrically-conductive elastic bodies 32 are disposed on a surface of the base member 31, and the substrate 60 is superposed on one end portion of the base member 31. The substrate 60 includes: the base material 61 having a plate shape; three electrodes 62 respectively to be in surface contact with end portions of three electrically-conductive elastic bodies 32; and three wires 63 which connect these electrodes 62 to the connector 64. The substrate 60 is fixed to the base member 31 by the thread 65 in a state where the substrate 60 is superposed on the base member 31, such that the three electrodes 62 are respectively in contact with the three electrically-conductive elastic bodies 32. Accordingly, the structure 1b in FIG. 13A is formed.

FIG. 13B is a perspective view schematically showing a state where the structure 1b in FIG. 13A is set to the structure 1a shown in FIG. 3B.

The structure 1b in FIG. 13A is placed upside down, from above (the Z-axis positive side) the structure 1a in FIG. 3B. At this time, the structures 1a, 1b are disposed such that an end portion of the substrate 60 is adjacent to an end portion of the base member 11 and an end portion of the base member 31 is adjacent to an end portion of the substrate 20. Accordingly, the three pairs of conductor wires 13 are sandwiched by the three electrically-conductive elastic bodies 12 and the three electrically-conductive elastic bodies 32. In this state, the base member 31 is connected to the base member 11 by a silicone rubber-based adhesive, a thread, or the like, whereby the base member 31 is fixed to the base member 11. In this manner, the load sensor 1 of Embodiment 4 is completed as shown in FIG. 13B.

The connector 64 of the structure 1b and the connector 24 of the structure 1a may each be connected to an external circuit, or alternatively, the connector 64 may be connected to the connector 24, and the connector 24 may be connected to an external circuit.

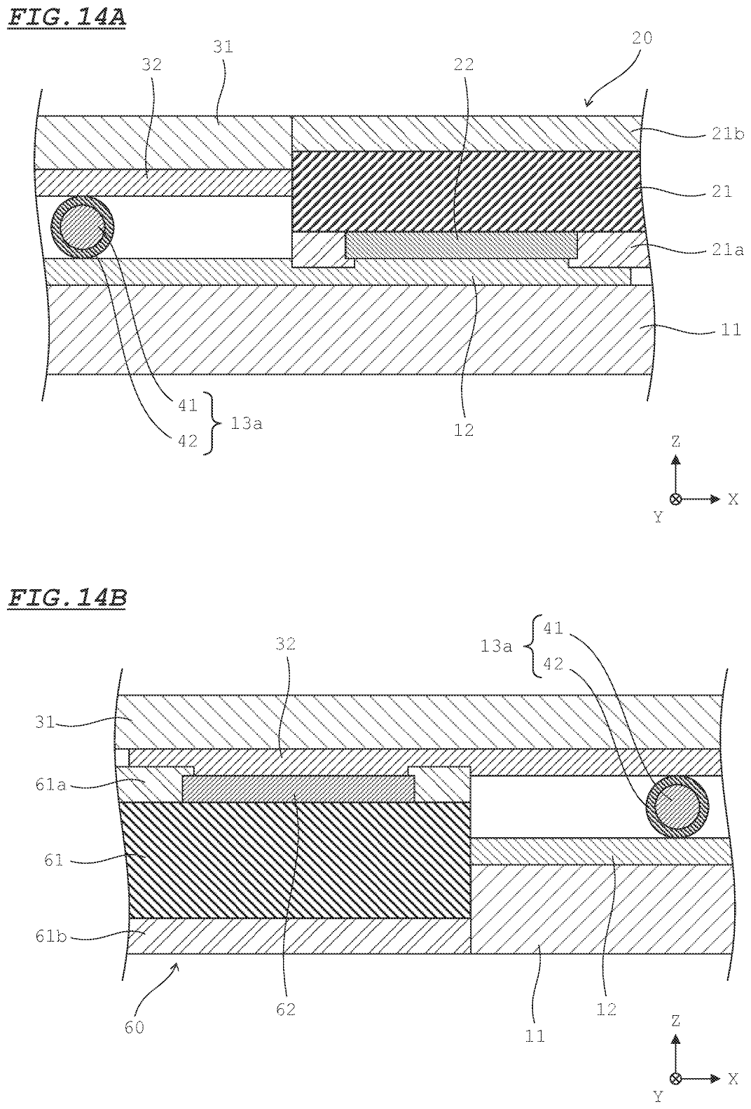

FIG. 14A is a diagram schematically showing a cross section of the vicinity of an electrode 22 obtained by cutting the load sensor 1 along a plane parallel to an X-Z plane passing through the center of the electrode 22. FIG. 14B is a diagram schematically showing a cross section of the vicinity of an electrode 62 obtained by cutting the load sensor 1 along a plane parallel to an X-Z plane passing through the center of the electrode 62.

As shown in FIG. 14A, similar to Embodiment 1 above, in the substrate 20, the electrode 22 is exposed on the lower side of the substrate 20, and the substrate 20 is fixed to the base member 11 in a state where the electrode 22 is pressed against the surface of the electrically-conductive elastic body 12. As shown in FIG. 14B, in the substrate 60, similar to the substrate 20, resists 61a, 61b are applied on the upper and lower sides of the base material 61. In the substrate 60, the electrode 62 is exposed on the upper side of the substrate 60, and the substrate 60 is fixed to the base member 31 in a state where the electrode 62 is pressed against the surface of the electrically-conductive elastic body 32.

<Effects of Embodiment 4>

According to Embodiment 4, the following effects are exhibited.

As shown in FIGS. 14A, 14B, the electrically-conductive member 41 is sandwiched by the electrically-conductive elastic body 12 and the electrically-conductive elastic body 32 through the dielectric body 42. Accordingly, the capacitance in the sensor part is increased, compared with that in Embodiment 1, and thus, change in the capacitance according to the load can be more finely detected, and the sensitivity of the load sensor 1 can be enhanced. Therefore, the detection accuracy of the load by the load sensor 1 can be enhanced. The upper and lower sides of each pair of conductor wires 13 are shielded by the electrically-conductive elastic bodies 12, 32, and thus, noise occurring in the electrically-conductive member 41 of the pair of conductor wires 13 can be suppressed.

As shown in FIG. 13B, the substrate 20 is disposed at one end (the end on the X-axis positive side) of the base member 11, and the substrate 60 is disposed at the other end (the end on the X-axis negative side) of the base member 31. According to this configuration, the substrate 20 and the substrate 20 do not overlap each other in the up-down direction. Therefore, the substrate 20 and the substrate 60 can be smoothly mounted to the base member 11 and the base member 31, respectively, and the structure 1b can be smoothly mounted to the structure 1a.

In the electrode 62 of the structure 1b as well, the modifications of Embodiment 1 or the configurations of Embodiment 2 may be applied. In the electrically-conductive elastic body 32 of the structure 1b as well, the configuration of Embodiment 3 may be applied.

### Embodiment 5

In Embodiment 1, as shown in FIG. 8, in the substrate 20, the connector 24 for connecting the load sensor 1 to an external circuit is disposed. However, a circuit part for load detection may be further disposed.

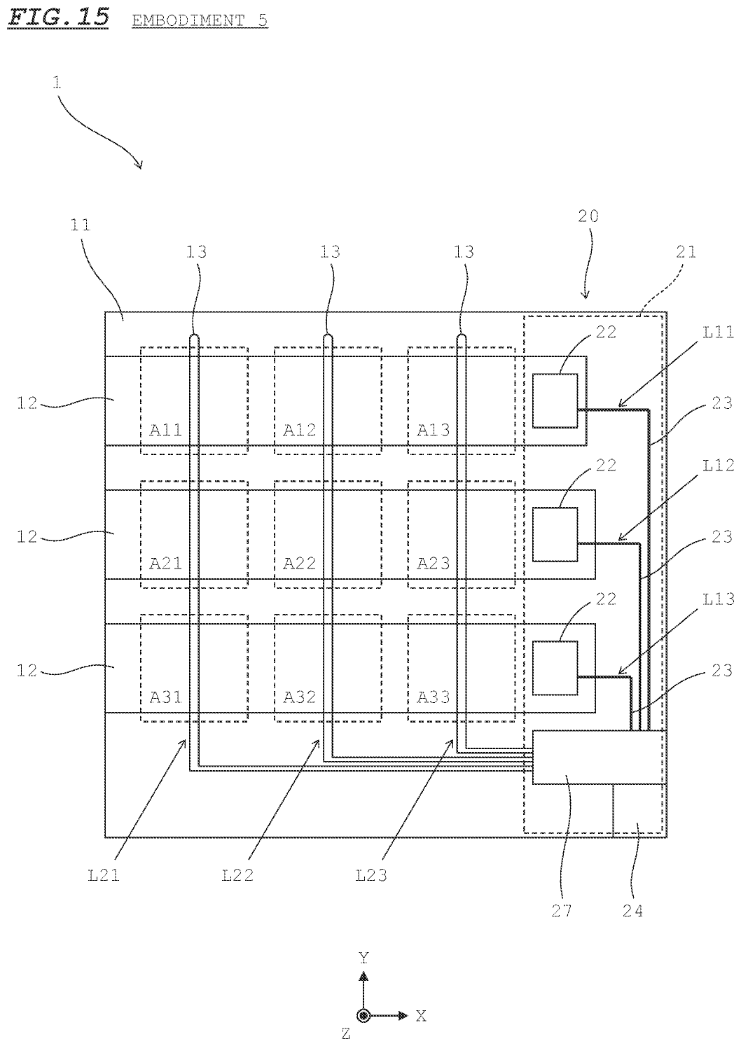

FIG. 15 is a plan view schematically showing the inside of the load sensor 1 viewed in the Z-axis negative direction, according to Embodiment 5. In FIG. 15, for convenience, the threads 14 are not shown, and the base member 11 and the base material 21 of the substrate 20 are shown in a transparent manner.

The substrate 20 of Embodiment 5 further includes a circuit part 27 between the three wires 23 and the connector 24. In addition to the three wires 23, the electrically-conductive members 41 of the three pairs of conductor wires 13 are connected to the circuit part 27. The circuit part 27 drives each sensor part of the load sensor 1, detects the capacitance in each sensor part, and calculates the load applied to the sensor part, based on the detected capacitance. Specifically, the circuit part 27 includes an RC circuit, a drive circuit, a detection circuit, an amplifier, and the like. The drive circuit includes a circuit that drives a multiplexer that switches the sensor parts in the RC circuit. The detection circuit includes a circuit that calculates a capacitance in the RC circuit, and a circuit that calculates a load, based on the capacitance.

<Effects of Embodiment 5>

According to Embodiment 5, the following effects are exhibited.

Since the substrate 20 includes the circuit part 27 which performs load detection, the load sensor 1 alone can calculate the load applied to each sensor part, and can output the calculated load from the circuit part 27 to an external circuit. Accordingly, a circuit part for load detection mounted in the external circuit can be reduced. Since the load is calculated by the circuit part 27 provided to the substrate 20, the load can be calculated with low noise, when compared with a case where the load is calculated by an external circuit as in Embodiment 1.

The circuit part 27 above is a circuit that performs up to calculation of the load. However, the circuit part 27 may include only a predetermined circuit part for load detection. For example, the circuit part 27 may include only a drive circuit, or may include a drive circuit part and a circuit part that calculates a capacitance. In this case as well, a part of the processes for load detection is performed in the load sensor 1, and thus, a circuit part for load detection mounted in an external circuit can be reduced.

<Other Modifications>

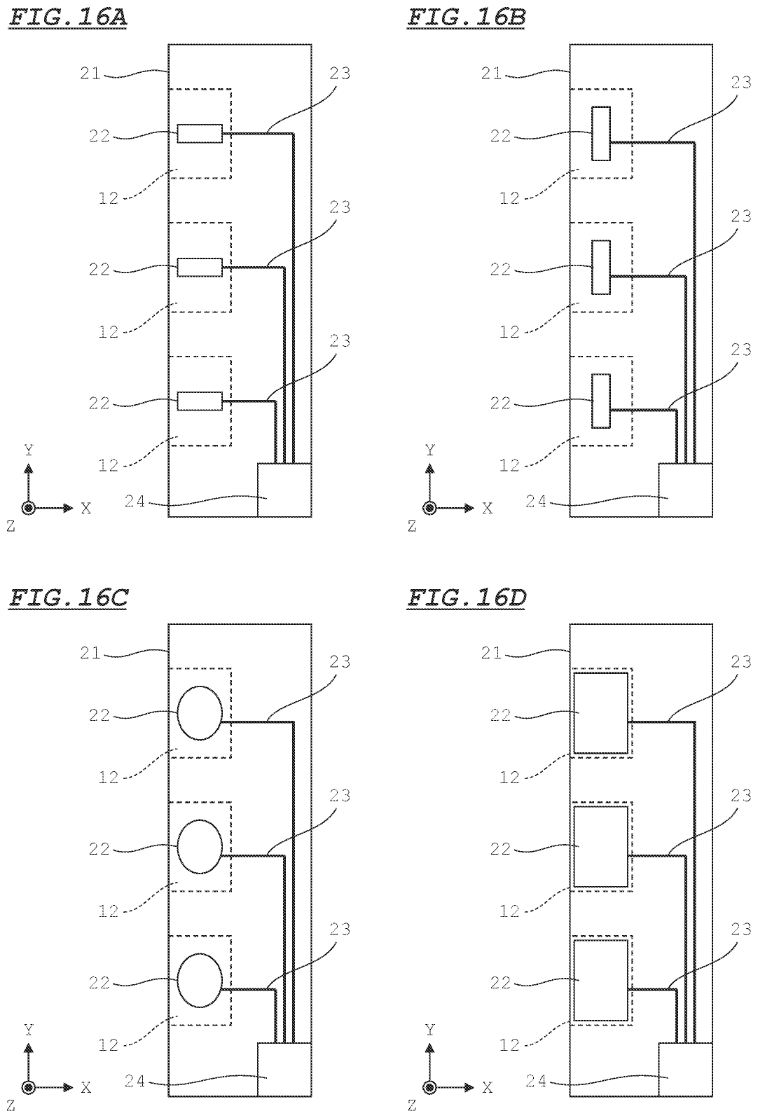

In Embodiments 1 to 5 above, the electrode 22 has a rectangular shape in a plan view and is configured to have a size a little smaller than that of the range where the electrically-conductive elastic body 12 and the substrate 20 overlap each other in a plan view. However, the shape and the size of the electrode 22 are not limited thereto. The shape of the electrode 22 may be a square, a circle, an ellipse, a trapezoid, or the like, and the size of the electrode 22 may be further larger or smaller. For example, the electrode 22 may have a configuration shown in FIGS. 16A to 16D.

In the example shown in FIG. 16A, the length in the Y-axis direction of the electrode 22 is shorter than that in Embodiments 1 to 5 above. In the example shown in FIG. 16B, the length in the X-axis direction of the electrode 22 is shorter than that in Embodiments 1 to 5 above. In the example shown in FIG. 16C, the shape of the electrode 22 is an elliptical shape. In the cases of FIGS. 16A to 16C, the contact area between the electrode 22 and the electrically-conductive elastic body 12 is smaller than that in Embodiments 1 to 3, 5 above. Therefore, from the viewpoint of increasing the contact area to decrease the electric resistance, Embodiments 1 to 5 above are more preferable. In the example shown in FIG. 16D, the electrode 22 is configured to have a size similar to that of the range where the electrically-conductive elastic body 12 and the substrate 20 overlap each other in a plan view. In this case, the contact area between the electrode 22 and the electrically-conductive elastic body 12 is larger than that in Embodiments 1 to 5 above. Therefore, the electric resistance at the interface between the electrode 22 and the electrically-conductive elastic body 12 can be further suppressed.

The electrode 22 only needs to be disposed at least at a position where the electrode 22 overlaps the electrically-conductive elastic body 12 in a plan view. Therefore, the electrode 22 may extend to the outside of the electrically-conductive elastic body 12 in a plan view. In Embodiment 4 above, the shape and the size of the electrode 62 are not limited to the shape and the size shown in FIG. 13A, and may be changed, as in the case of in FIG. 16A to 16D.

In Embodiments 1 to 5 above, one substrate 20 includes a plurality of electrodes 22 respectively corresponding to a plurality of electrically-conductive elastic bodies 12. However, not limited thereto, one substrate may include one electrode 22, and such a substrate may be disposed by the number of the electrically-conductive elastic bodies 12. In this case, one substrate is fixed to one electrically-conductive elastic body 12. In this case as well, the electrode 22 and the electrically-conductive elastic body 12 are in surface contact with each other. Therefore, the electric resistance at the interface between the electrode 22 and the electrically-conductive elastic body 12 can be suppressed to a low level. However, setting work is required for each substrate, and thus, from the viewpoint of work steps, it is more preferable that all of the electrodes 22 are provided to one substrate 20 as described above.

In Embodiment 4 above as well, one substrate may be disposed so as to correspond to one electrically-conductive elastic body 32, and such a substrate may include one electrode 62. In this case as well, the electric resistance at the interface between the electrode 62 and the electrically-conductive elastic body 32 can be suppressed to a low level. However, from the viewpoint of work steps, it is more preferable that all of the electrodes 62 are provided to one substrate 60 as described above.

In Embodiments 1 to 5 above, the wire 23 is formed integrally with the electrode 22, and is fixed to the substrate 20 by the resist 21a. Similarly, the wire 63 is formed integrally with the electrode 62, and is fixed to the substrate 60 by the resist 61a. However, the wire drawn from the electrode 22, 62 need not necessarily be set to the substrate 20, 60, and may be a cable wire. In this case, the cable wire is connected to the electrode 22, 62 by soldering or the like.

In Embodiments 1 to 5 above, the electrode 22, 62 is formed from an electrically-conductive metal material. However, not limited thereto, the electrode 22, 62 may be formed from a material obtained by causing an electrically-conductive metal to be included in a resin.

In Embodiments 1 to 5 above, the substrate 20 is fixed to the base member 11 by the thread 25, and the substrate 60 is fixed to the base member 31 by the thread 65. However, not limited thereto, the substrate 20, 60 may be fixed to the base member 11, 31 by a tubular member (eyelet) having a hole penetrating therethrough in the up-down direction, or by an insulative screw formed from a resin, a ceramic, or the like. The substrate 20, 60 may be fixed to the base member 11, 31 by the base member 11, 31 and the substrate 20, 60 being fixed to the housing of the load sensor 1.

In Embodiments 1 to 5 above, the thread 25, 65 is sewn by machine sewing, but the thread 25, 65 may be sewn by embroidering. However, machine sewing is more preferable because the seam of the thread 25 is stronger, than when the thread 25 is sewn by embroidering.

In Embodiment 2 above, the lower face of the first electrically-conductive material 51 in FIGS. 11A, 11B may have a shape similar to that of the irregularities 22a, the curved surface 22b, or the protruding face 22c, 22d of the modifications (FIG. 9A to FIG. 10B) of Embodiment 1. In Embodiment 2 above, the lower face of the second electrically-conductive material 52 in FIGS. 11A, 11B may have a shape similar to that of the irregularities 22a or the protruding face 22c, 22d of the modifications (FIG. 9A, FIGS. 10A, 10B) of Embodiment 1.

In Embodiment 2 above, the second electrically-conductive material 52 is formed from Ag (silver). However, not limited thereto, the second electrically-conductive material 52 only needs to be formed from a material having an electric conductivity higher than that of the first electrically-conductive material 51. For example, when the first electrically-conductive material 51 is formed from Al (aluminum), the second electrically-conductive material 52 may be formed from Ag (silver), Cu (copper), or Au (gold).

In Embodiment 3 above, the electrically-conductive filler of the first electrically-conductive elastic body 12a is C (carbon), and the electrically-conductive filler of the second electrically-conductive elastic body 12b is Ag (silver). However, not limited thereto, the electrically-conductive filler of the second electrically-conductive elastic body 12b only needs to have an electric conductivity higher than that of the electrically-conductive filler of the first electrically-conductive elastic body 12a. For example, when the electrically-conductive filler of the first electrically-conductive elastic body 12a is C (carbon), the electrically-conductive filler of the second electrically-conductive elastic body 12b may be Au (gold) or Cu (copper).

In Embodiments 1 to 5 above, all of the wires 23 and all of the electrically-conductive members 41 are connected to one connector 24. However, instead of this, a connector to which all of the wires 23 are connected and a connector to which all of the electrically-conductive members 41 are connected may be separately disposed. In this case, the two connectors are each connected to an external circuit.

In Embodiments 1 to 3, 5, the load sensor 1 includes three electrically-conductive elastic bodies 12 as shown in FIG. 1B. However, the load sensor 1 only needs to include at least one electrically-conductive elastic body 12. For example, the number of electrically-conductive elastic bodies 12 included in the load sensor 1 may be 1. In Embodiment 4 above, the load sensor 1 includes three sets of electrically-conductive elastic bodies 12, 32 opposing each other in the up-down direction. However, the load sensor 1 only needs to include at least one set of electrically-conductive elastic bodies 12, 32. For example, the number of sets of electrically-conductive elastic bodies 12, 32 included in the load sensor 1 may be 1.

In Embodiments 1 to 5 above, the load sensor 1 includes three pairs of conductor wires 13 as shown in FIG. 1B. However, the load sensor 1 only needs to include at least one pair of conductor wires 13. For example, the number of pairs of conductor wires 13 included in the load sensor 1 may be 1.

In Embodiments 1 to 5 above, one pair of conductor wires 13 has a shape in which two conductor wires 13a arranged in the X-axis direction are connected to each other at end portions in the Y-axis direction. However, instead of one pair of conductor wires 13, one conductor wire 13a may be disposed, or three or more conductor wires 13a may be disposed. Further, in a plan view, the shape of the pair of conductor wires 13 need not necessarily be a linear shape and may be a wave shape.

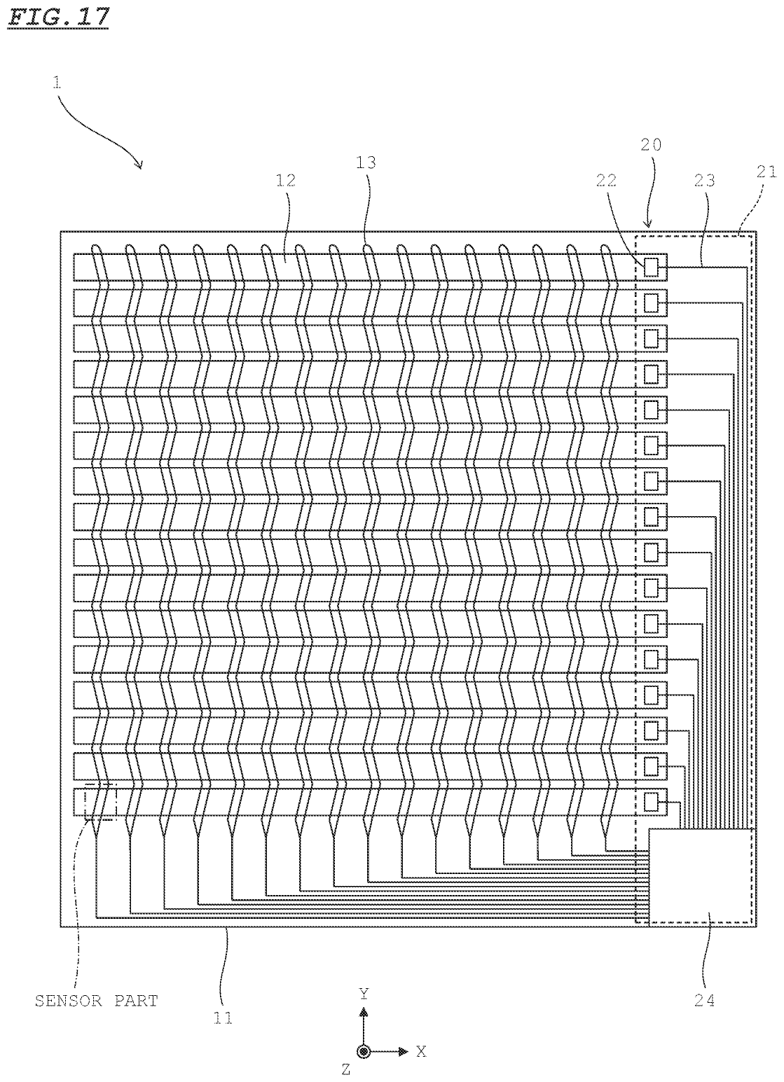

FIG. 17 is a plan view schematically showing a configuration in which the load sensor 1 includes 16 electrically-conductive elastic bodies 12, and 16 pairs of conductor wires 13. In this case, 16 electrodes 22 respectively connected to, while being pressed against, the 16 electrically-conductive elastic bodies 12 are set to one substrate 20. The substrate 20 need not necessarily include all of the electrodes 22, and for example, in FIG. 17, four substrates 20 each including four electrodes 22 may be disposed.

In Embodiments 1 to 3, 5, the dielectric body 42 is formed on the surface of the electrically-conductive member 41, but instead of this, the dielectric body 42 may be formed on the surface of the electrically-conductive elastic body 12. Similarly, in Embodiment 4 above, the dielectric body 42 is formed on the surface of the electrically-conductive member 41, but instead of this, the dielectric body 42 may be formed on the surfaces of the electrically-conductive elastic bodies 12, 32.

In Embodiments 1 to 5 above, the conductor wire 13a may be implemented by a twisted wire obtained by bundling a plurality of conductor wires each composed of an electrically-conductive member and a dielectric body. Alternatively, the conductor wire 13a may be implemented by a twisted wire obtained by bundling a plurality of electrically-conductive members, and a dielectric body covering this twisted wire. In these cases, flexibility of the conductor wire 13a can be increased, and the strength against bending of the conductor wire 13a can be increased.

In Embodiments 1 to 5 above, the shape of the base member 11, 31 is substantially a square in a plan view. However, not limited thereto, the shape of the base member 11, 31 may be a shape (rectangle, circle, etc.) other than a square.

In addition to the above, various modifications can be made as appropriate to the embodiments of the present invention without departing from the scope of the technical idea defined by the claims.

What is claimed is:

1. A load sensor comprising:
a base member;
an electrically-conductive elastic body having a band-like shape and disposed on a surface of the base member;
an electrically-conductive member disposed so as to be superposed on the electrically-conductive elastic body;
a dielectric body provided between the electrically-conductive elastic body and the electrically-conductive member; and
a substrate configured to connect the electrically-conductive elastic body and an external circuit, wherein
the substrate includes an electrode extending in a width direction and a length direction of the electrically-conductive elastic body, and is fixed to the base member in a state where the electrode is pressed against a surface of the electrically-conductive elastic body.

2. The load sensor according to claim 1, wherein
the electrode has irregularities at a surface thereof.

3. The load sensor according to claim 1, wherein
a surface of the electrode protrudes to the electrically-conductive elastic body side.

4. The load sensor according to claim 3, wherein
the surface of the electrode protrudes in a curved surface shape.

5. The load sensor according to claim 3, wherein
the surface of the electrode protrudes in a step-like manner.

6. The load sensor according to claim 1, wherein
the electrode includes:
a first electrically-conductive material; and
a second electrically-conductive material disposed on a surface of the first electrically-conductive material and exposed to outside, and
the second electrically-conductive material has an electric conductivity higher than that of the first electrically-conductive material.

7. The load sensor according to claim 6, wherein
the second electrically-conductive material includes silver.

8. The load sensor according to claim 6, wherein
a surface of the electrode protrudes in a curved surface shape to the electrically-conductive elastic body side, and
a portion, of the electrode, protruding in the curved surface shape is formed from the second electrically-conductive material.

9. The load sensor according to claim 1, wherein
the electrically-conductive elastic body includes a first electrically-conductive elastic body and a second electrically-conductive elastic body having an electric conductivity higher than that of the first electrically-conductive elastic body, and
the substrate is fixed to the base member such that the electrode is pressed against a surface of the second electrically-conductive elastic body.

10. The load sensor according to claim 9, wherein
the first electrically-conductive elastic body covers the second electrically-conductive elastic body, at least in a range where the electrically-conductive member is superposed,
the second electrically-conductive elastic body is exposed to outside at least in a range where the electrode is superposed, and
a width of the second electrically-conductive elastic body is smaller in the range where the electrically-conductive member is superposed than in the range where the electrode is superposed.

11. The load sensor according to claim 9, wherein
the second electrically-conductive elastic body includes silver.

12. The load sensor according to claim 1, wherein
the substrate is fixed to the base member by a connection tool in a vicinity of the electrode.

13. The load sensor according to claim 12, wherein
the connection tool is a thread.

14. The load sensor according to claim 1, wherein
the substrate includes a connector configured to connect the load sensor to the external circuit, and
the electrically-conductive member, as well as the electrode, is connected to the connector.

15. The load sensor according to claim 1, wherein
the substrate includes a predetermined circuit part for load detection.
